(19) United States
(12) Patent Application Publication
(10) Pub. No.: US 2024/0292210 A1
(43) Pub. Date: Aug. 29, 2024

(54) COMMUNICATION METHOD AND STATION

(71) Applicant: GUANGDONG OPPO MOBILE TELECOMMUNICATIONS CORP., LTD., Dongguan (CN)

(72) Inventors: Yang LIN, Dongguan (CN); Lei HUANG, Singapore (SG); Xinyi RAN, Dongguan (CN); Chaoming LUO, Dongguan (CN); Honghao JU, Dongguan (CN); Liuming LU, Dongguan (CN)

(21) Appl. No.: 18/657,137

(22) Filed: May 7, 2024

Related U.S. Application Data
(63) Continuation of application No. PCT/CN2021/130474, filed on Nov. 12, 2021.

(51) Int. Cl. H04W 12/02; H04W 12/69

(52) U.S. Cl. CPC H04W 12/02; H04W 12/69

(57) ABSTRACT

Provided is a communication method. The method includes: receiving, by a first station (STA), a control frame carrying first information and/or second information, wherein the first information is configured to identify the second information, and the second information comprises protected information.

### CROSS-REFERENCE TO RELATED APPLICATION

This application is a continuation of International Application No. PCT/CN2021/130474, filed Nov. 12, 2021, the entire disclosure of which is incorporated herein by reference.

### TECHNICAL FIELD

The present disclosure relates to the field of communications, and in particular, relates to a communication method and a station.

### BACKGROUND

In a wireless network, control frames may be transmitted between stations.

### SUMMARY

Embodiments of the present disclosure provide a communication method and a station that can enhance the security of communications.

A communication method is provided in some embodiments of the present disclosure. The method includes: receiving, by a first station (STA), a control frame carrying first information and/or second information, wherein the first information is configured to identify the second information, and the second information includes protected information.

A communication method is provided in some embodiments of the present disclosure. The method includes: transmitting, by a second STA, a control frame carrying first information and/or second information, wherein the first information is configured to identify the second information, and the second information includes protected information.

A first station is provided in some embodiments of the present disclosure. The first station includes: a receiver unit, configured to receive a control frame carrying first information and/or second information, wherein the first information is configured to identify the second information, and the second information includes protected information.

A second station is provided in some embodiments of the present disclosure. The second station includes: a transmitter unit, configured to transmit a control frame carrying first information and/or second information, wherein the first information is configured to identify the second information, and the second information includes protected information.

A first station is provided in some embodiments of the present disclosure. The first station includes a processor and a memory. The memory is configured to store a computer program, and the processor, when loading and running the computer program stored in the memory, causes the first station to perform the communication method as defined above.

A second station is provided in some embodiments of the present disclosure. The second station includes a processor and a memory. The memory is configured to store a computer program, and the processor, when loading and running the computer program stored in the memory, causes the second station to perform the communication method as defined above.

A chip for performing the communication method as defined above is provided in some embodiments of the present disclosure.

For example, the chip includes: a processor, wherein the processor, when loading and running a computer program in a memory, causes a device equipped with the chip to perform the communication method as defined above.

A non-transitory computer readable storage medium is provided in some embodiments of the present disclosure. A computer program stored in the non-transitory computer readable storage medium, when loaded and run by a device, causes the device to perform the communication method as defined above.

A computer program product is provided in some embodiments of the present disclosure. The computer program product includes one or more computer program instructions, wherein the one or more computer program instructions, when loaded and executed by a computer, cause the computer to perform the communication method as defined above.

A computer program is provided in some embodiments of the present disclosure. The computer program, when loaded and run by a computer, causes the computer to perform the communication method as defined above.

### BRIEF DESCRIPTION OF DRAWINGS

FIG. 1 is a schematic diagram of an application scenario according to some embodiments of the present disclosure.

FIG. 2 is a schematic diagram of a frame format of a trigger frame.

FIG. 3a is a schematic diagram of user information (User Info) field of an HE trigger frame.

FIG. 3b is a schematic diagram of a User Info field of an EHT trigger frame.

FIG. 4 is a schematic diagram of a frame format of a VHT NDPA frame.

FIG. 5 is a schematic diagram of an STA Info field for non-S1G STA of a VHT NDPA frame.

FIG. 6 is a schematic diagram of a frame format of an HE/EHT/ranging NDPA frame.

FIG. 7 is a schematic diagram of an STA Info field of an HE NDPA frame with AID11≠2047.

FIG. 8 is a schematic diagram of an STA Info field of an EHT NDPA frame.

FIG. 9 is a schematic diagram of an STA Info field of a ranging NDPA frame.

FIG. 10 is a schematic flowchart of a communication method according to some embodiments of the present disclosure.

FIG. 11 is a schematic flowchart of a communication method according to some other embodiments of the present disclosure.

FIG. 12 is a schematic diagram of a flowchart for a trigger frame and NDPA frame protection mechanism.

FIG. 13a is a schematic diagram of an Encryption Capability Information Element using a reserved element ID value.

FIG. 13b is a schematic diagram of an Encryption Capability Information Element using a reserved element extension ID value.

FIG. 13c is a schematic diagram indicating a control frame encryption capability in the Extended Capability Element.

FIG. 14 is a schematic diagram of an encrypted trigger frame format.

FIG. 15 is a schematic diagram of a frame format for an Encryption Information field of a trigger frame.

FIG. 16 is a schematic diagram of a trigger frame format where an encryption method is known.

FIG. 17 is a schematic diagram of a trigger frame format with unified encryption.

FIG. 18 is a schematic diagram of one example of a frame format for a ciphertext field of a trigger frame.

FIG. 19 is a schematic diagram of another example of a frame format for a ciphertext field of a trigger frame.

FIG. 20 is a schematic diagram of another example of a frame format for a ciphertext field of a trigger frame.

FIG. 21 is a schematic diagram comparing a unified encryption method and an individual encryption method.

FIG. 22 is a schematic diagram of a unified encryption for a trigger frame.

FIG. 23 is a schematic diagram of an individual encrypted trigger frame using a reserved AID to achieve compatibility.

FIG. 24 is a schematic diagram of a unified encrypted trigger frame using a two-bit fixed value to achieve compatibility.

FIG. 25 is a schematic diagram of an individual encrypted trigger frame using a two-bit fixed value to achieve compatibility.

FIG. 26 is a schematic diagram of a unified encrypted trigger frame using a three-bit fixed value to achieve compatibility.

FIG. 27 is a schematic diagram of an individual encrypted trigger frame using a three-bit fixed value to achieve compatibility.

FIG. 28 is a schematic diagram of implementations of encryption and decryption methods for a trigger frame.

FIG. 29 is a schematic diagram of an encrypted non-S1G VHT NDPA frame format.

FIG. 30 is a schematic diagram of an Encryption Information frame format for a non-S1G VHT NDPA frame.

FIG. 31 is a schematic diagram of a ciphertext field frame format for a non-S1G VHT NDPA frame.

FIG. 32 is a schematic diagram of an encrypted HE/EHT/ranging NDPA frame format.

FIG. 33 is a schematic diagram of an Encryption Information frame format for an HE/EHT/ranging NDPA frame.

FIG. 34 is a schematic diagram of a ciphertext field frame format for an HE/EHT/ranging NDPA frame.

FIG. 35 is a schematic diagram of an encryption information field of an HE trigger frame using a partial encryption method.

FIG. 36 is a schematic diagram of partial ciphertext and plaintext fields of an HE trigger frame using a partial encryption method.

FIG. 37 is a schematic diagram of operations on both the AP and STA sides with partial encryption.

FIG. 38 is a schematic diagram of an encryption information field of an HE NDPA frame.

FIG. 39 is a schematic diagram of an encryption information field of an EHT NDPA frame.

FIG. 40 is a schematic diagram of an encryption information field of a ranging NDPA frame.

FIG. 41 is a schematic diagram of partial ciphertext and plaintext fields of an HE/EHT/ranging NDPA frame.

FIG. 42 is a schematic block diagram of a first station according to some embodiments of the present disclosure.

FIG. 43 is a schematic block diagram of a second station according to some embodiments of the present disclosure.

FIG. 44 is a schematic block diagram of a communication device according to some embodiments of the present disclosure.

FIG. 45 is a schematic block diagram of a chip according to some embodiments of the present disclosure.

FIG. 46 is a schematic block diagram of a communication system according to some embodiments of the present disclosure.

### DETAILED DESCRIPTION

Technical solutions in the embodiments of the present disclosure will be described below with reference to the accompanying drawings in the embodiments of the present disclosure.

It is understandable that terms “system” and “network” herein are often used interchangeably. The term “and/or” herein is merely a way to describe an association relationship between associated objects, indicating that there can be three possible relationships. For example, “A and/or B” indicate that A exists alone, both A and B exist, and of B exists alone. In addition, the symbol “/” herein generally indicates an “or” relationship between the associated objects.

It is understandable that “indication” mentioned in the embodiments of the present disclosure may be a direct indication, an indirect indication or an indication that there is an association relationship. For example, A indicates B, which can mean that A indicates B directly, e.g., B may be acquired by A; or that A indicates B indirectly, e.g., A indicates C, wherein B may be acquired by B; or that an association relationship is present between A and B.

In the description of the embodiments of the present disclosure, a term “correspond” may indicate a direct or indirect corresponding relationship between two items, or indicate an associated relationship between two items. It may also indicate relationships such as indicating and being indicated, configuring and being configured, and the like.

To facilitate understanding of the technical solutions in the embodiments of the present disclosure, following explanation is provided for related technologies of the embodiments of the present disclosure. The following related technologies are considered as optional solutions and can be combined in any way with the technical solutions in the embodiments of the present disclosure, all falling within protection scope of the embodiments of the present disclosure.

The technical solutions in the embodiments of the present disclosure can be applied to various communication systems, such as wireless local area networks (WLAN), wireless fidelity (Wi-Fi) or other communication system.

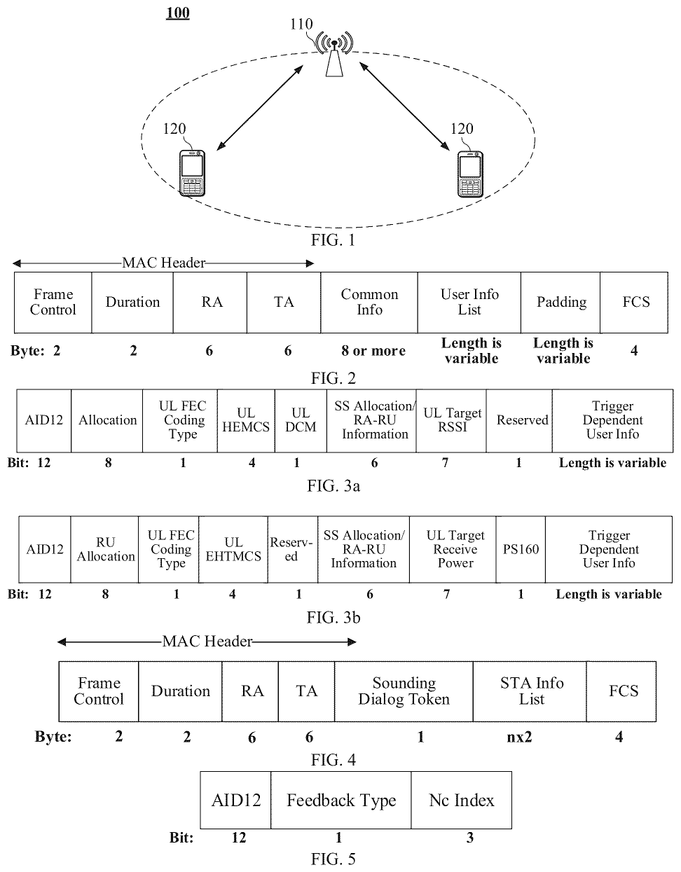

In some embodiments, a communication system 100 applied in the embodiments of the present disclosure is illustrated in FIG. 1. The communication system 100 includes an access point (AP) 110 and stations (STAs) 120 connected to the network by the access point 110.

In some scenarios, the AP is also referred to as AP STA, which means that, in a certain sense, the AP is also a type of STA.

In some scenarios, the STA is also referred to as a non-AP STA.

Communication within the communication system 100 involves communication between an AP and a non-AP STA, communication between non-AP STAs, or communication between an STA and a peer STA. The peer STA refers to a device communicating with the STA at an opposite terminal, for example, the peer STA could be an AP or a non-AP STA.

The AP functions as a bridge connecting wired and wireless networks, primarily serving to connect various wireless network clients together and then access the wireless network to the Ethernet. An AP device may be a terminal device (e.g., mobile phone) equipped with a Wi-Fi chip or a network device (e.g., router).

It is understandable that a role of an STA in the communication system is not absolute. For example, in some scenarios, when a mobile phone connects to a router, the mobile phone acts as a non-AP STA. When a mobile phone serves as a hotspot for another mobile phone, the mobile phone takes on a role of an AP.

Both the AP and the non-AP STA may be devices applied in the Internet of vehicles, nodes and sensors in Internet of things (IoT), smart cameras, smart remotes, smart water meters and electricity meters in smart homes, as well as sensors in smart cities.

In some embodiments, the non-AP STA supports the 802.11be standard. The non-AP STA also supports various current and future wireless local area network (WLAN) standards of the 802.11 series, such as 802.11ax, 802.11ac, 802.11n, 802.11g, 802.11b, and 802.11a.

In some embodiments, the AP is a device that supports the 802.11be standard. The AP may also be a device that supports various current and future WLAN standards of the 802.11 series, such as 802.11ax, 802.11ac, 802.11n, 802.11g, 802.11b, and 802.11a.

In the embodiments of the present disclosure, the STA may be a device that supports WLAN/Wi-Fi technology such as a mobile phone, a Pad, a computer, a virtual reality (VR) device, an augmented reality (AR) device, a wireless device in industrial control, a set-top box, a wireless device in self driving, an in-vehicle communication device, a wireless device in remote medical application, a wireless device in smart grids, a wireless device in transportation safety, a wireless device in smart cities, a wireless device in smart homes, a wireless communication chip/ASIC/SOC, and the like.

Frequency bands supported by the WLAN technology include but are not limited to low-frequency bands (e.g., 2.4 GHZ, 5 GHZ, or 6 GHZ) and high-frequency bands (e.g., 60 GHZ).

FIG. 1 illustrates one AP STA and two non-AP STAs as an example. In some embodiments, the communication system 100 includes a plurality of AP STAs and a varying number of non-AP STAs, which is not limited in the embodiments disclosed.

The identity identifier information of non-AP stations such as mobile phones is susceptible to unauthorized user tracking, potentially leading to privacy breaches.

In some embodiments, a trigger frame includes a high efficiency (HE) trigger frame and an extremely high throughput (EHT) trigger frame. A user information list (User Info List) field in the two frames includes one or more user information (User Info) fields, and each User Info field includes an association identifier AID12 field. For example, a frame format of the trigger frame, as shown in FIG. 2, includes the following fields: Frame Control, Duration, Receiver Address (RA), Transmitter Address (TA), Common Info, User Info List, Padding, and Frame Check Sequence (FCS). The first four fields belong to a media access control (MAC) header. Common Info includes 8 or more bytes (Octets), wherein one octet represents 8 bits. Sizes of the User Info List and Padding are variable. A specific usage of an association identifier (AID) in the trigger frame is shown in Table 1. FIG. 3a illustrates an example of a User Info field of an HE trigger frame, which includes AID12, Resource Unit (RU) Allocation, Uplink (UL) Forward Error Correction (FEC) Coding Type, UL HE Modulation and Coding Scheme (MCS), UL Dual Carrier Modulation (DCM), SS Allocation/RA-RU Information, UL Target Received Signal Strength Indication (RSSI), Reserved, and Trigger Dependent User Info. FIG. 3b illustrates an example of a User Info field of an EHT trigger frame, which includes AID12, RU Allocation, UL FEC Coding Type, UL EHTMCS, Reserved, SS Allocation/RA-RU Information, UL Target Receive Power, PS160 (Primary/Secondary 160 MHz), and Trigger Dependent User Info. The Trigger Dependent User Info has a variable length.

TABLE 1
Usage of AID in Trigger Frame

| AID12 subfield | Description |
|---|---|
| 0 | User Info field allocates one or more |
| | contiguous Random Access-Resource |
| | Units (RA-RUs) for associated STAs |
| 1-2007 | User Info field is addressed to an |
| | associated STA whose AID is equal to |
| | the value in the AID12 subfield |
| 2008-2044 | Reserved |
| 2045 | User Info field allocates one or more |
| | contiguous RA-RUs for unassociated STAs |
| 2046 | Unallocated RU |
| 2047-4094 | Reserved |
| 4095 | Start of Padding field |

(2) A null data PPDU announcement (NDPA) frame includes a very high throughput (VHT) NDPA frame, an HE NDPA frame, an EHT NDPA frame, and a ranging NDPA frame. A station information list (STA Info List) field in each of the frames includes one or more station information (STA Info) fields, but each of the STA Info fields only includes one AID field.

For example, as shown in FIG. 4, a frame format of the VHT NDPA frame includes Frame Control, Duration, RA, TA, Sounding Dialog Token, station information list (STA Info List), Padding and FCS. VHT NDPA frames can be divided into S1G STA VHT NDPA and non-S1G STA VHT NDPA. S1G is an abbreviation for Sub 1 GHz (below 1 GHz frequency band). In the present disclosure, a non-S1G STA VHT NDPA is taken as an example for explanation, and an example of a frame format of the non-S1G STA VHT NDPA is shown in FIG. 5. The frame format includes AID12, Feedback Type and Nc Index. The Nc Index may represent a column index value (of a compressed beamforming feedback matrix).

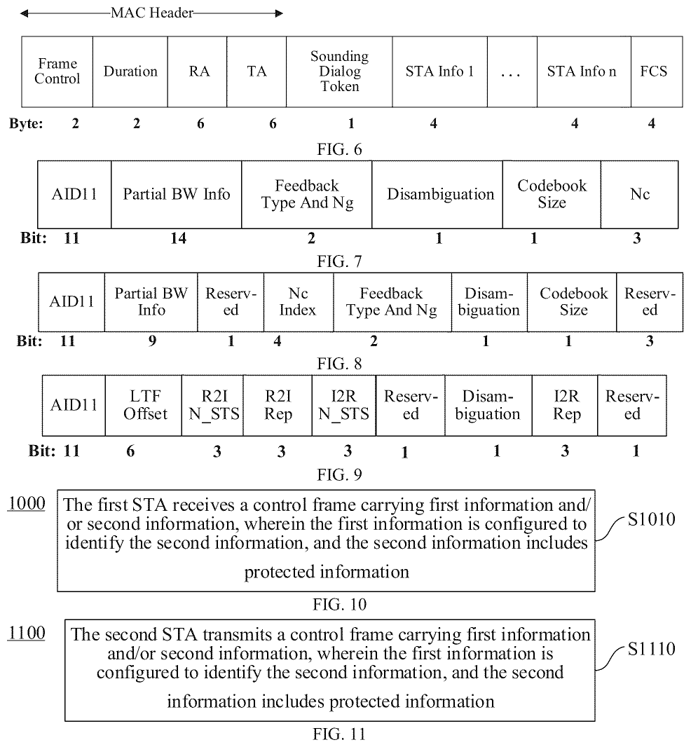

An example of a frame format of the HE NDPA frame, the EHT NDPA frame, or the ranging NDPA frame (abbreviated as HE/EHT/ranging NDPA frame) is illustrated in FIG. 6. The frame format includes Frame Control, Duration, RA, TA, Sounding Dialog Token, station information 1 (STA Info 1) to station information n (STA Info n) and FCS. STA Info fields where AID11≠2047 is shown in FIG. 7. The STA Info fields include the following fields: AID11, partial bandwidth information (Partial BW Info), Feedback Type and Ng, Disambiguation, Codebook Size and Nc. STA Info fields where AID=2047 are not associated with a specific STA. The STA Info fields include the following fields: Disallowed Subchannel Bitmap, Reserved, Disambiguation and Reserved. The Ng represents the number of carriers grouped into one.

The STA Info field of the EHT NDPA frame is illustrated in FIG. 8. The STA Info field includes the following fields: AID11, Partial BW Info, Reserved, Nc Index, Feedback Type And Ng, Disambiguation, Codebook Size and Reserved. The STA Info field of the ranging NDPA frame is illustrated in FIG. 9. The STA Info field includes the following fields: AID11, long training field (LTF) Offset, R2I N_STS, R2I Rep, I2R N_STS, Reserved, Disambiguation, I2R Rep and Reserved. The R2I represents responder to initiator. The R2I N_STS represents the number of space-time streams. The R2I Rep represents the number of repetitions of the LTF in the R2I NDP. The I2R Rep represents the number of repetitions of the LTF in the I2R NDP. The specific usage of AID in the NDPA frame is shown in Table 2. The Disambiguation field in the HE/EHT/ranging NDPA frame is configure for disambiguation, which means that it helps different versions of STAs to correctly process the respective types of control frames.

TABLE 2
Specific Usage of AID in NDPA Frame

| AID subfield | Description |
|---|---|
| 0 | STA Info field is addressed to the associated AP. |
| 1-2007 | STA Info field is addressed to an associated STA |
| | whose AID is equal to the value in the AID11 |
| | subfield if the NDP Announcement frame is not |
| | a ranging variant. |
| | STA Info field is addressed to an unassociated |
| | STA or an associated STA whose RSID/AID is |
| | equal to the value in the RSID11/AID11 subfield if the |
| | NDP Announcement frame is a ranging variant. |
| 2008-2042 | Reserved |
| 2043 | STA Info field contains a sequence authentication code |
| | if the NDP Announcement frame is a ranging variant. |
| | This AID11 value is reserved otherwise. |
| 2044 | STA Info field contains a partial TSF if the NDP |
| | Announcement frame is a ranging variant. |
| | This AID11 value is reserved otherwise. |
| 2045 | STA Info field contains ranging measurement |
| | parameters if the NDP Announcement |
| | frame is a ranging variant. |
| | This AID11 value is reserved otherwise. |
| 2046 | Reserved |
| 2047 | STA Info field contains a disallowed subchannel bitmap |
| | if the NDP Announcement frame is an HE variant. |
| | This AID11 value is reserved otherwise. |

In the table, the TSF represents a timing synchronization function. The partial TSF in the table represents truncated data of a synchronized time value. For example, the partial TSF involves removing the most significant 38 bits and the least significant 10 bits from the 64 TSF timer bits.

Since the identity identifier information such as AID in the trigger frame and NDPA frame is susceptible to unauthorized user tracking, a failure to protect the information could lead to a leakage of a mapping relationship between a user AID and a MAC address, as well as enable determination of whether the user is in the current area. Additionally, unauthorized users might acquire communication activities of a user's ongoing services and behavioral patterns, such as traffic consumption and other information, by eavesdropping on resource unit (RU) and other parameter information in the frame a plurality of times. This poses a significant threat to user privacy security. For a control frame carrying unprotected identity identifier information such as an AID and related parameter information, serious privacy exposure issues may arise. Because of the privacy exposure risk associated with the control frame, it is essential to provide a detailed protection solution for the control frame.

FIG. 10 is a schematic flowchart of a communication method 1000 according to some embodiments of the present disclosure. In some embodiments, the method is applicable to the system shown in FIG. 1 but is not limited to it. The method includes at least some of the following content.

In S1010, the first STA receives a control frame carrying first information and/or second information, wherein the first information is configured to identify the second information, and the second information includes protected information.

In some embodiments, STAs includes both an AP STA and a non-AP STA. In the embodiments of the present disclosure, the first STA is illustrated as a non-AP STA, and the second STA as an AP STA. The first STA receives the control frame from the second STA. The control frame has various types, such as the trigger frame, the NDPA frame, and the like. The second information in the control frame includes protected information. In some embodiments, the protected information includes encrypted information and/or digested information. The first information in the control frame is configured to identify the second information. For example, the first information includes encryption information, and the first information is configured to identify encrypted information in the second information. For another example, the first information includes digestion information, and the first information is configured to identify digested information in the second information. For another example, the first information includes the encryption information and the digestion information, and the first information is configured to identify the encrypted information and the digested information in the second information.

In some embodiments, information in the control frame that needs to be encrypted and/or digested is referred to as original information or original target information. The information after encryption is referred to as the encrypted information or encrypted target information, and the information after digestion is referred to as the digested information or digested target information.

In some embodiments, the communication method includes an announcement process. During the announcement process, the first STA and the second STA announce their respective protection capabilities to each other.

In some embodiments, the communication method further includes: transmitting, by the first STA, protection capability information of the first STA for the control frame. The protection capability information includes encryption capability information and/or digestion capability information. For example, the first STA transmits the encryption capability information and/or digestion capability information of the first STA for the control frame to the second STA.

In some embodiments, the protection capability information of the first STA for the control frame is contained in an association request frame and/or a first authentication frame transmitted by the first STA. For example, during an association phase, the first STA announces that the first STA possesses encryption capability and/or digestion capability by transmitting the association request frame to the second STA, wherein the association request frame carries encryption capability information and/or digestion capability information. For another example, during an authentication phase, the first STA announces that the first STA possesses the encryption capability and/or the digestion capability by transmitting the first authentication frame to the second STA, wherein the first authentication frame carries the encryption protection capability and/or the digestion protection capability.

In some embodiments, the association request frame and/or the first authentication frame include a first protection capability information field. The first protection capability information field carries the protection capability information of the first STA for the control frame. For example, the first protection capability information field is at least one of a first encryption capability information field, a first digestion capability information capability field, a first digestion and encryption capability information field, and the like.

In some embodiments, the first protection capability information field includes at least one of: a first field indicating trigger frame protection capability, a first field indicating NDPA frame protection capability, a first field indicating multi-STA block acknowledgment (BA) frame protection capability, a first field indicating BA frame protection capability, and a reserved field. The reserved field is also referred to as a reservation field.

In some embodiments, the first protection capability information field includes one or more of digestion capability information field, encryption capability information field, and digestion and encryption capability information field.

For example, in the case that the first protection capability information field is the first encryption capability information field, the first field indicating trigger frame protection capability is a first field indicating trigger frame encryption capability, the first field indicating NDPA frame protection capability is a field indicating first NDPA frame encryption capability, the first field indicating multi-STA BA frame protection capability is a first field indicating multi-STA BA frame encryption capability, and the first field indicating BA frame protection capability is a first field indicating BA frame encryption capability.

For another example, in the case that the first protection capability information field is the first digestion capability information field, the first field indicating trigger frame protection capability is a field indicating first trigger frame digestion capability, the first field indicating NDPA frame protection capability is a first field indicating NDPA frame digestion capability, the first field indicating multi-STA BA frame protection capability is a first field indicating multi-STA BA frame digestion capability, and the first field indicating BA frame protection capability is a first field indicating BA frame digestion capability.

For another example, in the case that the first protection capability information field is the first digestion and encryption capability information field, the first field indicating trigger frame protection capability is a first field indicating trigger frame digestion and encryption capability, the first field indicating NDPA frame protection capability is a first field indicating NDPA frame digestion and encryption capability, the first field indicating multi-STA BA frame protection capability is a field indicating first multi-STA BA frame digestion and encryption capability, and the first field indicating BA frame protection capability is a first field indicating BA frame digestion and encryption capability.

For another example, in the first protection capability information field, the first field indicating trigger frame protection capability is a first field indicating trigger frame encryption capability, the first field indicating NDPA frame protection capability is a first field indicating NDPA frame digestion capability, the first field indicating multi-STA BA frame protection capability is a first field indicating multi-STA BA frame encryption and digestion capability, and the first field indicating BA frame protection capability is a first field indicating BA frame digestion capability.

In some embodiments, the first protection capability information field further includes a first element identifier field.

In some embodiments, the first element identifier field carries a specified element identifier. In the embodiments of the present disclosure, the specified element identifier belongs to a reserved element identifier. The reserved element identifier indicates that an element identifier value currently belongs to a reserved value, and for devices conforming to published standards, the reserved value belongs to an unprocessed value.

In some embodiments, the first protection capability information field further includes a second element identifier field and/or a first element identifier extension field.

In some embodiments, a value of the second element identifier field is 255; and the first element identifier extension field carries a specified element extension identifier. In the embodiments of the present disclosure, the specified element extension identifier belongs to a reserved element extension identifier. The reserved element extension identifier indicates that an element extension identifier value currently belongs to the reserved value, and for devices conforming to published standards, the reserved value belongs to the unprocessed value.

In some embodiments, the association request frame and/or the first authentication frame include a first extended capability field. The first extended capability field carries the protection capability information of the first STA for the control frame.

In some embodiments, the first extended capability field includes at least one of: a second field indicating trigger frame protection capability, a second field indicating NDPA frame protection capability, a second field indicating multi-STA BA frame protection capability, a second field indicating BA frame protection capability, and a reserved field.

For example, the second field indicating trigger frame protection capability is a second field indicating trigger frame encryption capability, the second field indicating NDPA frame protection capability is a second field indicating NDPA frame encryption capability, the second field indicating multi-STA BA frame protection capability is a second field indicating multi-STA BA frame encryption capability, and the second field indicating BA frame protection capability is a second field indicating BA frame encryption capability.

For another example, the second field indicating trigger frame protection capability is a second field indicating trigger frame digestion capability, the second field indicating NDPA frame protection capability is a second field indicating NDPA frame digestion capability, the second field indicating multi-STA BA frame protection capability is a second field indicating multi-STA BA frame digestion capability, and the second field indicating BA frame protection capability is a second field indicating BA frame digestion capability.

For another example, the second field indicating trigger frame protection capability is a second field indicating trigger frame digestion and encryption capability, the second field indicating NDPA frame protection capability is a second field indicating NDPA frame digestion and encryption capability, the second field indicating multi-STA BA frame protection capability is a field indicating second multi-STA BA frame digestion and encryption capability, and the field indicating second BA frame protection capability is a second field indicating BA frame digestion and encryption capability.

In some embodiments, the first extended capability field further includes a third element identifier field.

In some embodiments, the communication method further includes: receiving, by the first STA, protection capability information of the second STA for the control frame.

In some embodiments, the protection capability information of the second STA for the control frame is contained in an association response frame and/or a second authentication frame received by the first STA. For example, during the association phase, the first STA announces that the second STA possesses encryption capability and/or digestion capability by receiving the association response frame from the second STA, wherein the association response frame carries encryption capability information and/or digestion capability information. For another example, during the authentication phase, the first STA announces that the second STA possesses the encryption capability and/or the digestion capability by receiving the second authentication frame from the second STA, wherein the second authentication frame carries the encryption protection capability and/or the digestion protection capability.

In some embodiments, the association response frame and/or the second authentication frame include a second protection capability information field. The second protection capability information field carries the protection capability information of the second STA for the control frame. For example, the second protection capability information field is at least one of a second encryption capability information field, a second digestion capability information capability field, a second digestion and encryption capability information field, and the like.

In some embodiments, the second protection capability information field includes at least one of: a third field indicating trigger frame protection capability, a third field indicating NDPA frame protection capability, a third field indicating multi-STA BA frame protection capability, a third field indicating BA frame protection capability, and a reserved field.

For example, in the case that the second protection capability information field is the second encryption capability information field, the third field indicating trigger frame protection capability is a third field indicating trigger frame encryption capability, the third field indicating NDPA frame protection capability is a third field indicating NDPA frame encryption capability, the third field indicating multi-STA BA frame protection capability is a third field indicating multi-STA BA frame encryption capability, and the third field indicating BA frame protection capability is a third field indicating BA frame encryption capability.

For another example, in the case that the second protection capability information field is the second digestion capability information field, the third field indicating trigger frame protection capability is a field indicating third trigger frame digestion capability, the third field indicating NDPA frame protection capability is a third field indicating NDPA frame digestion capability, the third field indicating multi-STA BA frame protection capability is a third field indicating multi-STA BA frame digestion capability, and the third field indicating BA frame protection capability is a third field indicating BA frame digestion capability.

For another example, in the case that the second protection capability information field is the second digestion and encryption capability information field, the third field indicating trigger frame protection capability is a third field indicating trigger frame digestion and encryption capability, the third field indicating NDPA frame protection capability is a third field indicating NDPA frame digestion and encryption capability, the third field indicating multi-STA BA frame protection capability is a third field indicating multi-STA BA frame digestion and encryption capability, and the third field indicating BA frame protection capability is a third field indicating BA frame digestion and encryption capability.

In some embodiments, the second protection capability information field further includes a fourth element identifier field.

In some embodiments, the fourth element identifier field carries a specified element identifier.

In some embodiments, the second protection capability information field further includes a fifth element identifier field and/or a second element identifier extension field.

In some embodiments, a value of the fifth element identifier field is 255; and the second element identifier extension field carries a specified element extension identifier.

In some embodiments, the association response frame and/or the second authentication frame include a second extended capability field. The second extended capability field carries the protection capability information of the second STA for the control frame.

In some embodiments, the second extended capability field further includes at least one of: a fourth field indicating trigger frame protection capability, a fourth field indicating NDPA frame protection capability, a fourth field indicating multi-STA BA frame protection capability, a fourth field indicating BA frame protection capability, and a reserved field.

For example, the fourth field indicating trigger frame protection capability is a fourth field indicating trigger frame encryption capability, wherein the fourth field indicating NDPA frame protection capability is a fourth field indicating NDPA frame encryption capability, the fourth field indicating multi-STA BA frame protection capability is a fourth field indicating multi-STA BA frame encryption capability, and the fourth field indicating BA frame protection capability is a fourth field indicating BA frame encryption capability.

For another example, the fourth field indicating trigger frame protection capability is a fourth field indicating trigger frame digestion capability, wherein the fourth field indicating NDPA frame protection capability is a fourth field indicating NDPA frame digestion capability, the fourth field indicating multi-STA BA frame protection capability is a fourth field indicating multi-STA BA frame digestion capability, and the fourth field indicating BA frame protection capability is a fourth field indicating BA frame digestion capability.

For another example, the fourth field indicating trigger frame protection capability is a fourth field indicating trigger frame digestion and encryption capability, wherein the fourth field indicating NDPA frame protection capability is a fourth field indicating NDPA frame digestion and encryption capability, the fourth field indicating multi-STA BA frame protection capability is a fourth field indicating multi-STA BA frame digestion and encryption capability, and the fourth field indicating BA frame protection capability is a fourth field indicating BA frame digestion and encryption capability.

In some embodiments, the second extended capability field includes a sixth element identifier field.

In some embodiments, the communication method further includes: identifying, by the first STA and based on the first information, the second information. For example, the first STA digests and/or decrypts the second information based on the first information. The processing schemes of the first STA and the second STA are associated. In the case that the second STA acquires the second information by encryption, the first STA identifies the second information by decryption. In the case that the second STA acquires the second information by digestion, the first STA identifies the second information by digestion. In the case that the second STA acquires the second information by digestion and encryption, the first STA identifies the second information by digestion and encryption.

In some embodiments, identifying, by the first STA and based on the first information, the second information includes: acquiring a first verification information by decrypting, by the first STA and based on the first information, the second information.

In some embodiments, the first information includes encryption information representing basic information required for an encryption process. For example, the encryption information includes at least one of an encryption algorithm, the number of original information, and a ciphertext length corresponding to each piece of original information. For example, in the case that the encryption algorithm and the ciphertext length corresponding to each piece of original information are known, the encryption information only carries the number of the original information. The second information includes the encrypted information or the encrypted target information. The information in the control frame that needs to be encrypted is referred to as the original information, and the information acquired by encrypting the original information is referred to as the encrypted information or the encrypted target information. The first STA acquires the first verification information by decrypting, based on one or more of the encryption algorithm, the number of the original information and the ciphertext length corresponding to each piece of original information, the second information. In the case that the first STA has acquired partial information of the original information in advance, such as an AID of the first STA, the first STA determines whether the first verification information is consistent with the known AID of the first STA by comparing the first verification information with the known AID of the first STA. In the case that the first verification information is consistent with the known AID of the first STA, the second information received by the first STA is the second information intended for the first STA. In the case that the first verification information is not consistent with the known AID of the first STA, the second information received by the first STA is not the second information intended for the first STA.

In the embodiments of the present disclosure, the encryption algorithm includes but is not limited to symmetric encryption, such as advanced encryption standard (AES) 128, AES192, AES256, and/or asymmetric encryption, such as elliptic curve cryptography (ECC) p256, ECC p384, and the like.

In some embodiments, decrypting, by the first STA and based on the first information, the second information includes: extracting, by the first STA and based on the number of the original information and/or the length corresponding to each piece of information, the second information; and extracting, by the first STA and based on the encryption algorithm, the valid ciphertext from the second information and decrypting the valid ciphertext.

For example, k is taken to represent the length corresponding to each piece of information. The meaning of k may vary for different encryption methods.

In the case of unified encryption (and a partial encryption), k is taken to represent a length of original text that needs to be encrypted (e.g., part of the fields to be encrypted in each piece of original information), measured in bytes.

In the case of unified encryption (and full encryption), k is not required, or k is taken to represent the length of the original text that needs to be encrypted (e.g., all the fields in each piece of original information), measured in bytes.

In the case of individual encryption, k is taken to represent a ciphertext length corresponding to each piece of original information, such as original User Info or original STA Info.

For a unified encryption method (e.g., a plurality of User Info encrypted together with the same key), with the number of the original information M=2, and an original text length for each piece of original information being 3 bytes (using the trigger frame as an example, with partial encryption being 3 bytes), a total original text length is 6 bytes. An encryption algorithm requires an input that is an integer multiple of 16 bytes, with an output length of the encryption algorithm being the same as an input length. Whether the trigger frame is encrypted User Info or unencrypted User Info, the trigger frame needs to be transmitted in a 5-byte format (where the fixed format, consisting of AID and the following part, together forms 5 bytes such that the STA can correctly identify or ignore). Hence, it can be inferred that the ciphertext length corresponding to the second information is ┌2×3=16┐×16)=5┐×5=20 bytes. Here, a valid ciphertext is 16 bytes. In the embodiments of the present disclosure, ┌ ┐ denotes rounding up to the nearest integer.

For an independent encryption method (i.e., each User Info is encrypted with an individual key), with the number of the original information M=2, and the original text length for each piece of original information being 3 bytes (using the trigger frame as an example, with partial encryption being 3 bytes), an encryption algorithm requires an input that is an integer multiple of 16 bytes. The output length of the encryption algorithm is the same as the input length. Each piece of original information needs to be padded to ┌3÷16┐×16=16 bytes. The length k of the ciphertext after encryption is also ┌3÷16┐×16=16 bytes. For the trigger frame, whether it is encrypted information or unencrypted User Info information, it must be transmitted in a 5-byte format (where the fixed format, consisting of AID plus the following part, together forms 5 bytes such that the STA can correctly identify or ignore). Hence, it can be inferred that the ciphertext length corresponding to the second information is M×(┌k÷5┐×5)=2×(┌16÷5┐×5)=40 bytes, wherein a valid ciphertext is 32 bytes. The method for calculating the ciphertext length mentioned above involves separately making up for, after individual encryption, the ciphertext corresponding to each User Info. In the case of individual encryption, other methods may be employed to generate the ciphertext corresponding to the second information. For example, concatenating the ciphertext corresponding to each User Info and then making up for afterward. With this method, the acquired ciphertext length corresponding to the second information is ┌M×k÷5┐×5=┌2×16÷5┐×5=35. In the embodiments of the present disclosure, ┌ ┐ denotes rounding up to the nearest integer.

Different encryption algorithms require different lengths of valid ciphertext. For example, a valid ciphertext length for AES128 is 16 bytes. The first STA extracts the first 16 bytes from a 20-byte second information, ignoring the last 4 bytes of padding. Then, the first STA acquires a decrypted plaintext by decrypting the extracted valid ciphertext using a key. The first STA and the second STA may exchange keys in advance. The key may be a symmetric key or an asymmetric key, depending on the characteristics of the encryption algorithm.

In some embodiments, decryption the valid ciphertext further includes: continuing to decrypt protected content within the valid ciphertext in the case that an AID read from the valid ciphertext is a specified AID.

In the embodiments of the present disclosure, the specified AID belongs to a reserved AID value. The reserved AID value indicates that the AID value currently belongs to the reserved value, and for devices conforming to published standards, the reserved value belongs to the unprocessed value.

In some embodiments, decryption the valid ciphertext further includes: stopping the decryption in the case that the AID read from the valid ciphertext is the specified AID. For example, in the case that the AID read from the valid ciphertext is a reserved AID value, the protected content within the valid ciphertext is skipped, and the decryption is stopped.

For example, an AP transmits the trigger frame to STA1 (AID=10) and STA2 (AID=31), and an original text includes two User Info totaling 10 bytes, wherein the two User Info are intended for STA1 and STA2 respectively.

In the case of unified (and full) AES128 encryption:

The trigger frame includes five consecutive 5-byte structures, with a valid ciphertext of 16 bytes. STA1, STA2, and STA3 simultaneously receive the frame and all parse the AID from the first 5 bytes. STA1 and STA2 find it is the specific AID (such as 2038) defined in the method. Therefore, STA1 and STA2 parse the following encryption information field, such that STA1 and STA2 calculate that the ciphertext should include 20 bytes, and the valid ciphertext should include 16 bytes. STA1 and STA2 continue to parse the four 5-byte structures, (i.e., the encrypted information fields), and ignore the AID, Disambiguation, and padding therein. STA1 and STA2 extract the valid ciphertext of 16 bytes. However, STA3 (a legacy STA) finds a reserved AID value. STA3 ignores the five bytes corresponding to the AID, and continues to process every other 5 bytes until the process is completed.

STA1 and STA2 both decrypt the 16 bytes using the same key, and acquire the original text of two User Info fields totaling 10 bytes. Subsequently, STA1 compares the AID in the first User Info of the original text with its own AID. In the case that the AIDs are consistent, STA1 processes data in the User Info. STA1 then proceeds to compare the AID in the second User Info of the original text with its own AID. In the case that AIDs are not consistent, STA1 ignores data in the User Info. STA2 follows a similar processing method as STA1, and sequentially compares the AID in each User Info.

### In the Case of Independent (and Full) AES128 Encryption:

The trigger frame includes eight consecutive 5-byte structures, with a valid ciphertext of 32 bytes. STA1, STA2, and STA3 simultaneously receive the frame. All of STA1, STA2, and STA3 parse the AID from the first five bytes and find it is the specific AID (e.g., 2038) defined in the method. Therefore, they parse the following encrypted information field, such that STA1, STA2 and STA3 calculate that the ciphertext should include 35 bytes (it is the case that the ciphertext is concatenated and made up for afterward), and the valid ciphertext should include 32 bytes. STA1 and STA2 continue to parse the seven 5-byte structures, and ignore the AID, Disambiguation, and padding therein. They extract the valid ciphertext of 32 bytes (that is, the encrypted information field). However, STA3 (a legacy STA) finds a reserved AID value. STA3 ignores the five bytes corresponding to the AID, and continues to process every other 5 bytes until the process is completed.

STA1 acquires the 5 bytes in the first User Info of the original text by decrypting the first 16 bytes using an individual key. STA1 compares the bytes with its own AID. In the case that the bytes are consistent with the AID, STA1 processes the data in the User Info and does not decrypt the last 16 bytes anymore.

STA2 acquires a 5-byte decrypted output (which is basically entirely different from the original text) by decrypting the first 16 bytes using an individual key. STA2 compares the output with its own AID. In the case that the output is not consistent with the AID, STA2 ignores the data in the User Info. STA2 then acquires the five bytes in the second User Info of the original text by continuing to decrypt the 16 bytes afterwards. STA2 compares the bytes with its own AID. In the case that the bytes are consistent with the AID, STA2 processes the data in the User Info.

In some embodiments, the number of the original information, the length corresponding to each piece of information, and the encryption algorithm are acquired from the first information. For example, upon receiving a control frame from the second STA, the first STA acquires the number of the original information, the length corresponding to each piece of information and the encryption algorithm from the first information in the control frame.

In some embodiments, the encryption algorithm and the length corresponding to each piece of information are known, and the number of the original information is acquired from the first information. For example, the first STA and the second STA acquire the length corresponding to each piece of information and the encryption algorithm in advance. Upon receiving the control frame from the second STA, the first STA acquires the number of the original information from the first information in the control frame. Additionally, in the case of a method where all original information is uniformly encrypted, the length corresponding to each piece of information is not acquired, and only the number of the original information is acquired. In the case of a method where each piece of original information is individually encrypted, the length corresponding to each piece of information and the number of the original information need to be acquired.

In some embodiments, decrypting, by the first STA and based on the first information, the second information further includes: extracting, by the first STA, valid plaintext from the decrypted plaintext.

Additionally, the plaintext acquired by decrypting the valid ciphertext includes a padding field and/or a scrambling field. A type of the control frame is determined based on fields such as frame type in the control frame, and the valid plaintext is extracted based on the type of the control frame. For example, assuming the control frame is a trigger frame, a valid user information (User Info) length k is 5 bytes. In the case of unified and full encryption, the valid plaintext is extracted in 5-byte units from the valid ciphertext, and the extracted valid plaintext is considered as the original information. In the case of unified and partial encryption, k may be three bytes, and the valid plaintext is extracted in 3-byte units, and the original information is acquired by inserting unencrypted plaintext. In the case of individual and full encryption, k is five bytes, and the valid plaintext is extracted in 5-byte units from the valid ciphertext. The extracted valid plaintext is considered as the original information. In the case of individual and partial encryption, k is two bytes, and the valid plaintext is extracted in 2-byte units from the valid ciphertext, and the original information is acquired by inserting the unencrypted plaintext.

In some embodiments, the valid plaintext is part of the fields of the original information. Decrypting, by the first STA and based on the first information, the second information further includes: restoring and acquiring the original information by inserting, by the first STA, the valid plaintext into the unencrypted plaintext of the original information in the order corresponding to the respective fields in the frame format and the encryption order of the original information. For example, in the case of a method where M pieces of original information in the control frame are partially encrypted, fields A and B in the original information are partially encrypted. After the valid plaintext is acquired by decryption, it is also necessary to determine, based on the frame format of the control frame, positions and orders where the fields A and B included in the valid plaintext need to be inserted. The fields A and B are sequentially inserted into the unencrypted plaintext based on the corresponding order of the fields A and B in the control frame and the encryption order of the M pieces of original information, thereby restoring and acquiring the original information.

In some embodiments, identifying, by the first STA and based on the first information, the second information includes: acquiring a second verification information by digesting, by the first STA and based on a digest algorithm, all or part of the fields of the original information; and confirming, by the first STA, the identification as successful in the case that the second verification information is consistent with the second information.

For example, the second STA acquires the second information by digesting the original information. In this case, the first STA acquires the second verification information by using the digest algorithm in the first information to digest part of the fields, such as the AID field of the first STA, of the original information. The second verification information is compared with the second information received from the second STA. In the case that the second verification information is consistent with the second information, that the second STA acquires the second information by using the same AID field and digest algorithm as the first STA. In the case that the second verification information is not consistent with the second information, the second information is not the second information intended for the first STA.

For another example, the second STA acquires the second information by digesting all the fields of the original information and transmits the second information along with a plaintext of part of the fields of the original information to the first STA. The first STA, upon digesting all the fields of the original information, compares the original information with the received second information. In the case that the original information is consistent with the received second information, the first STA uses the received plaintext of part of the fields of the original information according to actual needs. In the case that the original information is not consistent with the received second information, the second information is not the second information intended for the first STA.

In the embodiments of the present disclosure, the digest algorithm includes, but is not limited to, hash-based message authentication code, cipher block chaining MAC (CBC-MAC), Galois message authentication code (GMAC), counter with CBC-MAC (CCM) (based on AES and CBC-MAC), Galois/counter mode (GCM) (based on AES and GMAC), and the like.

In some embodiments, identifying, by the first STA and based on the first information, the second information includes: acquiring a third verification information by digesting, by the first STA and based on a digest algorithm, all or part of the fields of the original information; acquiring a fourth verification information by encrypting, by the first STA and based on an encryption algorithm, the third verification information; and in the case that the fourth verification information is consistent with the second information, confirming, by the first STA, the identification as successful.

For example, the second STA acquires a generated second information by digesting and encrypting the original information. In this case, the first STA acquires the third verification information by using the digest algorithm in the first information to digest the part of the fields (such as the AID field of the first STA) of the original information. Subsequently, the fourth verification information is acquired by using the encryption algorithm in the first information to encrypt the third verification information. The fourth verification information is then compared with the second information received from the second STA. In the case that the fourth verification information is consistent with the second information, the second STA acquires second information by digesting and encrypting using the same AID field, digest algorithm, and encryption algorithm as the first STA. In the case that the fourth verification information is not consistent with the second information, the second information is not the second information intended for the first STA.

For another example, the second STA acquires the second information by digesting and encrypting all the fields of the original information, and transmits the second information along with the plaintext of part of the fields of the original information to the first STA. The first STA acquires the third verification information by digesting all the fields of the original information. Subsequently, the fourth verification information is acquired by encrypting the third verification information using the encryption algorithm in the first information. The fourth verification information is then compared with the received second information. In the case that the fourth verification information is consistent with the second information, the first STA uses the received plaintext of the part of the fields of the original information as needed. In the case that the fourth verification information is not consistent with the second information, the second information is not the second information intended for the first STA.

In some embodiments, the second information includes the encrypted information and the digested information. Identifying, by the first STA and based on the first information, the second information includes: acquiring a fifth verification information by decrypting, by the first STA and based on an encryption algorithm, the encrypted information; acquiring a sixth verification information by digesting, by the first STA and based on a digest algorithm, the fifth verification information; and in the case that the sixth verification information is consistent with the digested information, confirming, by the first STA, the identification as successful.

For example, the second STA acquires the digested information by digesting the original information, acquires the encrypted information by encrypting the original information, and uses the encrypted information and the digested information together as the second information. In this case, the first STA acquires the fifth verification information by decrypting the encrypted information in the second information using the encryption algorithm in the first information. Moreover, the first STA acquires the sixth verification information by digesting the fifth verification information using the digest algorithm in the first information. The sixth verification information is then compared with the digested information in the received second information. In the case that the sixth verification information is consistent with the digested information, the second STA acquires the second information by digesting and encrypting using the same original information, digest algorithm, and encryption algorithm as the first STA. In the case that the sixth verification information is not consistent with the digested information, the second information is not the second information intended for the first STA.

In some embodiments, the first information includes at least one of the following fields: a specified AID, a protection method, a length of a processed result corresponding to each piece of original information, and the number of the original information. The specified AID in the first information belongs to the reserved AID value.

In some embodiments, the protection method includes an encryption algorithm and/or a digest algorithm.

In some embodiments, in the case that the protection method includes the encryption algorithm, the length of the processed result corresponding to each piece of original information includes a length corresponding to each piece of information. In the case that the protection method includes the digest algorithm, the length of the processed result corresponding to each piece of original information includes a digest length corresponding to each piece of original information. In the case that the protection method includes the encryption algorithm and the digest algorithm, the length of the processed result corresponding to each piece of original information includes the length corresponding to each piece of information and the digest length.

In some embodiments, the second information includes a reserved AID value and/or a disambiguation bit, wherein the reserved AID value in the second information is different from the reserved AID in the first information.

In some embodiments, the second information further includes a protected content field.

In some embodiments, the protected content field further includes an encrypted content field and/or a digested content field.

In some embodiments, the second information further includes a padding field and/or a scrambling field.

In some embodiments, the second information is acquired by uniformly processing M pieces of original information, wherein M is a positive integer. For example, a piece of encrypted information is acquired by uniformly encrypting a plurality of pieces of original information. For another example, a piece of digested information is acquired by uniformly digesting a plurality of pieces of original information.

In some embodiments, the second information is acquired by individually processing M pieces of original information, wherein M is a positive integer. For example, a plurality of pieces of encrypted information are acquired by individually encrypting a plurality of pieces of original information, with each piece of original information corresponding to a piece of encrypted information. For another example, a plurality of pieces of digested information by individually digesting a plurality of pieces of original information, with each piece of original information corresponding to a piece of digested information.

In some embodiments, the second information is acquired by processing part of the fields of M pieces of original information, wherein M is a positive integer.

In some embodiments, the first information further includes a partial protection information field. The partial protection information field is configured to indicate part of the fields in the original information that need to be protected.

In some embodiments, the control frame is a trigger frame. The second information in the trigger frame includes the protected user information (User Info). For example, the protected User Info includes the encrypted User Info and/or the digested User Info.

In some embodiments, the protected User Info in the trigger frame includes one protected User Info field. The protected User Info field is acquired by processing M original User Info fields, wherein M is a positive integer. For example, in the unified encryption method, the encrypted User Info in the trigger frame includes one encrypted User Info field. The encrypted User Info field is acquired by encrypting M original User Info fields. For another example, in the unified digestion method, the encrypted User Info in the trigger frame includes one digested User Info field. The digested User Info field is acquired by digesting M original User Info fields.

In some embodiments, the protected User Info in the trigger frame includes a plurality of protected User Info fields. Each of the protected User Info field is acquired by processing one original User Info field. For example, in the individual encryption method, the encrypted User Info in the trigger frame includes a plurality of encrypted User Info fields. Each encrypted User Info field is acquired by encrypting one original User Info field. For another example, in the individual digestion method, the encrypted User Info in the trigger frame includes a plurality of encrypted User Info fields. Each encrypted User Info field is acquired by digesting one original User Info field.

In some embodiments, the protected User Info in the trigger frame includes a partially protected User Info field and an unprotected User Info field. The partially protected User Info field is acquired by processing part of the fields in M original User Info fields. For example, in the partial encryption method, the encrypted User Info in the trigger frame includes a partially encrypted User Info field and an unencrypted User Info field. The partially encrypted User Info field is acquired by encrypting part of the fields in M original User Info fields. For another example, in the partial digestion method, the digested User Info in the trigger frame includes a partially digested User Info field and an undigested User Info field. The partially digested User Info field is acquired by digesting part of the fields in M original User Info fields.

In some embodiments, in the trigger frame, a reserved AID value is included in the partially protected User Info field and the unprotected User Info field every other 5 bytes. The reserved AID value is configured for disambiguation. For example, a reserved AID value is included in the partially encrypted User Info field and the unencrypted User Info field every other 5 bytes. For another example, a reserved AID value is included in the partially digested User Info field and the undigested User Info field every other 5 bytes.

In some embodiments, a total length of a protected part in the trigger frame is ┌M1×k1÷5┐×5 bytes, wherein k1 represents a length of a processed result corresponding to the original User Info field, M1 represents the number of the original User Info fields, and both k1 and M1 are positive integers.

In some embodiments, a total length of a protected part in the trigger frame is ┌M1×k1÷5┐×5 bytes, wherein k1 represents a length of a processed result corresponding to part of the fields in the original User Info field, M1 represents the number of the original User Info fields, and both k1 and M1 are positive integers.

In some embodiments, in the case of individual encryption, the total length of the protected part in the trigger frame is also M1×(┌k1÷5┐×5) bytes.

In the embodiments of the present disclosure, the protected part is an encrypted part and/or a digested part. For example, the protected part is the second information.

In some embodiments, first 12 bits of the protected User Info in the trigger frame include at least two disambiguation bits.

In some embodiments, the disambiguation bits in the first 12 bits of the protected User Info in the trigger frame include an 11^{th} bit B10 and a 12^{th} bit B11, wherein a numerical value composed of B10 and B11 along with previous 10 bits of protected content is a reserved AID value.

In some embodiments, B10=0 and B11=1. For example, setting B10 and B11 to such values ensures that the numerical value composed of the first 12 bits falls within a range of 2048 to 3071, which forms a reserved AID value.

In some embodiments, the disambiguation bits in the first 12 bits of the protected User Info in the trigger frame include a 10^{th} bit B9, an 11^{th} bit B10, and a 12^{th} bit B11, wherein a numerical value composed of B9, B10 and B11 along with previous 9 bits of protected content is a reserved AID value.

In some embodiments, B9=0, B10=1, and B11=1. For example, setting B9, B10 and B11 to such values ensures that the numerical value composed of the first 12 bits falls within a range of 3072 to 3583, which forms a reserved AID value.

In some embodiments, the control frame is an NDPA frame. The second information in the NDPA frame includes a protected station information (STA Info). For example, the protected STA Info includes an encrypted STA Info and/or a digested STA Info.

In some embodiments, the first information of the NDPA frame further includes a disambiguation bit.

In some embodiments, the protected STA Info in the NDPA frame includes one protected STA Info field. The protected STA Info field is acquired by processing M original STA Info fields, wherein M is a positive integer. For example, in the unified encryption method, the encrypted STA Info in the NDPA frame includes one encrypted STA Info field. The encrypted STA Info field is acquired by encrypting M original STA Info fields. For another example, in the unified digestion method, the digested STA Info in the NDPA frame includes one digested STA Info field. The digested STA Info field is acquired by digesting M original STA Info fields.

In some embodiments, the protected STA Info in the NDPA frame includes a plurality of protected STA Info fields. Each of the protected STA Info field is acquired by processing one original STA Info field. For example, in the individual encryption method, the encrypted STA Info in the NDPA frame includes a plurality of encrypted STA Info fields. Each encrypted STA Info field is acquired by encrypting one original STA Info field. For another example, in the individual digestion method, the digested STA Info in the NDPA frame includes a plurality of digested STA Info fields. Each digested STA Info field is acquired by digesting one original STA Info field.

In some embodiments, the protected STA Info in the NDPA frame includes a partially protected STA Info field and an unprotected STA Info field. The partially protected STA Info field is acquired by processing part of the fields in M original STA Info fields. For example, in the partial encryption method, the encrypted STA Info in the NDPA frame includes a partially encrypted STA Info field and an unencrypted STA Info field. The partially encrypted STA Info field is acquired by encrypting part of the fields in M original STA Info fields. For another example, in the partial digestion method, the digested STA Info in the NDPA frame includes a partially digested STA Info field and an undigested STA Info field. The partially digested STA Info field is acquired by digesting part of the fields in M original STA Info fields. In some embodiments, the NDPA frame is a VHT NDPA frame.

In some embodiments, in the VHT NDPA frame, a reserved AID value is included in the partially protected STA Info field and the unprotected STA Info field every other 2 bytes. The reserved AID value is configured for disambiguation. For example, in the VHT NDPA frame, a reserved AID value is included in the partially encrypted STA Info field and the unencrypted STA Info field every other 2 bytes. For another example, in the VHT NDPA frame, a reserved AID value is included in the partially digested STA Info field and the undigested STA Info field every other 2 bytes.

In some embodiments, a total length of a protected part in the VHT NDPA frame is ┌M2×k2÷2┐×2 bytes, wherein k2 represents a length of a processed result corresponding to the original STA Info field, M2 represents the number of the original STA Info fields, and both k2 and M2 are positive integers. For example, the length of the processed result corresponding to the original STA Info field includes a ciphertext length corresponding to the original STA Info field and a digest length corresponding to the original STA Info field.

In some embodiments, the total length of the protected part in the VHT NDPA frame is ┌M2×k2÷2┐×2 bytes, wherein k2 is a length of the processed result corresponding to part of the fields in the original STA Info field, M2 is the number of the original STA Info fields, and both k2 and M2 are positive integers. For example, the length of the processed result corresponding to part of the fields in the original STA Info field includes a ciphertext length corresponding to part of the fields in the original STA Info field and a digest length corresponding to part of the fields in the original STA Info field.

In some embodiments, in the case of individual encryption, the total length of the protected part in the VHT NDPA frame is also ┌M2×k2÷2┐×2 bytes.

In some embodiments, in the VHT NDPA frame, the disambiguation bit in the first 12 bits of the protected STA Info is the 12^{th} bit B11.

In some embodiments, the NDPA frame is an HE NDPA frame, an EHT NDPA frame, or a ranging NDPA frame.

In some embodiments, in the HE NDPA frame, the EHT NDPA frame, or the ranging NDPA frame, a reserved AID value is included in the partially protected STA Info field and the unprotected STA Info field every other 4 bytes. The reserved AID value is configured for disambiguation. For example, in the HE NDPA frame, the EHT NDPA frame or the ranging NDPA frame, a reserved AID value is included in the partially encrypted STA Info field and the unencrypted STA Info field every other 4 bytes. For another example, in the HE NDPA frame, the EHT NDPA frame or the ranging NDPA frame, a reserved AID value is included in the partially digested STA Info field and the undigested STA Info field every other 4 bytes.

In some embodiments, a total length of the protected part in the HE NDPA frame, the EHT NDPA frame or the ranging NDPA frame is ┌M3×k3÷4┐×4 bytes, wherein k3 represents the length of the processed result corresponding to the original STA Info field, M3 represents the number of the original STA Info fields, and both k3 and M3 are positive integers.

In some embodiments, a total length of the protected part in the HE NDPA frame, the EHT NDPA frame or the ranging NDPA frame is ┌M3×k3÷4┐×4 bytes, wherein k3 represents the length of the processed result corresponding to part of the fields in the original STA Info field, M3 represents the number of the original STA Info fields, and both k3 and M3 are positive integers.

In some embodiments, in the case of individual encryption, the total length of the protected part in the HE NDPA frame, the EHT NDPA frame or the ranging NDPA frame is also ┌M3×k3÷4┐×4 bytes.

In the embodiments of the present disclosure, ┌ ┐ denotes rounding up to the nearest integer.

In some embodiments, in the HE NDPA frame, the EHT NDPA frame or the ranging NDPA frame, the disambiguation bit in first 28 bits of the protected STA Info is a 28^{th} bit B27.

In the embodiments of the present disclosure, the use of reserved AID values and/or disambiguation bits is advantageous for compatibility with legacy STAs.

In the embodiments, the security of communication between stations is improved by protecting the information in the control frame transmitted between stations, such as the control frame received by the first STA from the second STA. Further, the leakage of private information in the control frame is prevented, achieving privacy protection.

FIG. 11 is a schematic flowchart of a communication method 1100 according to some embodiments of the present disclosure. In some embodiments, the method is applicable to the system shown in FIG. 1, which is, however, not limited thereto. The method includes at least some of the following content.

In S1110, the second STA transmits a control frame carrying the first information and/or the second information, wherein the first information is configured to identify the second information, and the second information includes protected information.

In some embodiments, STAs include both an AP STA and a non-AP STA. In some embodiments of the present disclosure, the first STA is illustrated as a non-AP STA, and the second STA as an AP STA.

In some embodiments, the communication method further includes: receiving, by the second STA, protection capability information of the first STA for the control frame.

In some embodiments, the protection capability information of the first STA for the control frame is contained in an association request frame and/or a first authentication frame transmitted the first STA.

In some embodiments, the association request frame and/or the first authentication frame include a first protection capability information field. The first protection capability information field carries the protection capability information of the first STA for the control frame.

In some embodiments, the first protection capability information field includes at least one of: a first field indicating trigger frame protection capability, a first field indicating null data PPDU announcement (NDPA) frame protection capability, a first field indicating multi-STA BA frame protection capability field, a first field indicating BA frame protection capability, and a reserved field.

In some embodiments, the first protection capability information field further includes a first element identifier field.

In some embodiments, the first element identifier field carries a specified element identifier.

In some embodiments, the first protection capability information field further includes a second element identifier field and/or a first element identifier extension field.

In some embodiments, a value of the second element identifier field is 255; and the first element identifier extension field carries a specified element extension identifier.

In some embodiments, the association request frame and/or the first authentication frame include a first extended capability field. The first extended capability field carries the protection capability information of the first STA for the control frame.

In some embodiments, the first extended capability field includes at least one of: a second field indicating trigger frame protection capability, a second field indicating NDPA frame protection capability, a second field indicating multi-STA BA frame protection capability, a second field indicating BA frame protection capability, and a reserved field.

In some embodiments, the first extended capability field further includes a third element identifier field.

In some embodiments, the communication method further includes: transmits, by the second STA, the protection capability information of the second STA for the control frame.

In some embodiments, the protection capability information of the second STA for the control frame is contained in an association response frame and/or a second authentication frame received by the first STA.

In some embodiments, the association response frame and/or the second authentication frame include a second protection capability information field. The second protection capability information field carries the protection capability information of the second STA for the control frame.

In some embodiments, the second protection capability information field includes at least one of: a third field indicating trigger frame protection capability, a third field indicating NDPA frame protection capability, a third field indicating multi-STA BA frame protection capability, a third field indicating BA frame protection capability, and a reserved field.

In some embodiments, the second protection capability information field further includes a fourth element identifier field.

In some embodiments, the fourth element identifier field carries a specified element identifier.

In some embodiments, the second protection capability information field further includes a fifth element identifier field and/or a second element identifier extension field.

In some embodiments, a value of the fifth element identifier field is 255; and the second element identifier extension field carries a specified element extension identifier.

In some embodiments, the association response frame and/or the second authentication frame include a second extended capability field. The second extended capability field carries the protection capability information of the second STA for the control frame.

In some embodiments, the second extended capability field further includes at least one of: a fourth field indicating trigger frame protection capability, a fourth field indicating NDPA frame protection capability, a fourth field indicating multi-STA BA frame protection capability, a fourth field indicating BA frame protection capability, and a reserved field.

In some embodiments, the second extended capability field includes a sixth element identifier field.

In some embodiments, the communication method further includes: acquiring the second information by processing, by the second STA and based on the first information, the original information. For example, the processing of the original information by the second STA includes digestion and/or encryption.

In some embodiments, acquiring the second information by processing, by the second STA and based on the first information, the original information includes: acquiring the second information by encrypting, by the second STA and based on the first information, the original information. For example, processing schemes of the first STA and the second STA are associated. In the case that the second STA acquires the second information by encryption, the first STA identifies the second information by decryption. In the case that the second STA acquires the second information by digestion, the first STA identifies the second information by digestion. In the case that the second STA acquires the second information by digestion and encryption, the first STA identifies the second information by digestion and encryption.

In some embodiments, acquiring the second information by processing, by the second STA and based on the first information, the original information includes: acquiring a valid ciphertext by padding and encrypting, by the second STA and based on an encryption algorithm, the original information; and acquiring the second information by padding, by the second STA, the valid ciphertext. For example, the original information of a particular control frame includes 5 bytes, in the case of using AES128 as the encryption algorithm, the second STA needs to pad the original information up to 16 bytes. AES128 is taken to acquire the valid ciphertext by encrypting padded information. To ensure compatibility with legacy STAs, the valid ciphertext is expanded to 20 bytes and then added with 10 bytes of plaintext that do not require encryption. In the control frame transmitted by the second STA, a length of the user information list is 30 bytes. Upon receiving the control frame, the first STA decrypts the control frame. Details of the decryption process can refer to the relevant descriptions in the embodiments of the communication method performed by the first STA as described above.

In some embodiments, acquiring the second information by processing, by the second STA and based on the first information, the original information includes: acquiring the second information by digesting, by the second STA and based on the first information, all or part of the fields of the original information.

For example, the second STA acquires the second information by digesting all or part of the fields of the original information. In this case, the first STA acquires a second verification information by digesting all or part of the fields of the original information using the digest algorithm in the first information. The second verification information is compared with the second information received from the second STA. In the case that the second verification information is consistent with the second information, the second STA acquired the second information by digesting using the same original information and digest algorithm as the first STA. In the case that the second verification information is not consistent with the second information, the second information is not the second information intended for the first STA.

In some embodiments, acquiring the second information by processing, by the second STA and based on the first information, the original information further includes: acquiring the second information by digesting, by the second STA and based on the first information, all or part of the fields of the original information and encrypting digested information.

For example, the second STA acquires a generated second information by digesting and encrypting the original information. In this case, the first STA acquires a third verification information by digesting all or part of the fields of the original information using the digest algorithm in the first information. Subsequently, a fourth verification information is acquired by encrypting the third verification information using the encryption algorithm in the first information. The fourth verification information is then compared with the second information received from the second STA. In the case that the fourth verification information is consistent with the second information, the second STA acquired the second information by digesting and encrypting using the same original information, digest algorithm and encryption algorithm as the first STA. In the case that the fourth verification information is not consistent with the second information, the second information is not the second information intended for the first STA.

In some embodiments, acquiring the second information by processing, by the second STA and based on the first information, the original information includes: acquiring encrypted information by encrypting, by the second STA and based on the first information, the original information; acquiring digested information by digesting, by the second STA and based on the first information, the original information; and acquiring, by the second STA, the second information based on the encrypted information and the digested information.

For example, the second STA acquires the digested information by digesting the original information, acquires the encrypted information by encrypting the original information, and uses the encrypted information and the digested information together as the second information. In this case, the first STA acquires a fifth verification information by decrypting the encrypted information in the second information using the encryption algorithm in the first information. Moreover, the first STA acquires a sixth verification information by digesting the fifth verification information using the digest algorithm in the first information. The sixth verification information is then compared with the digested information in the received second information. In the case that the sixth verification information is consistent with the digested information, the second STA acquires the second information by digesting and encrypting using the same original information, digest algorithm and encryption algorithm as the first STA. In the case that the sixth verification information is not consistent with the digested information, the second information is not the second information intended for the first STA.

In some embodiments, the first information includes at least one of the following fields: the specified AID, the protection method, the length of the processed result corresponding to each piece of original information, and the number of the original information.

In the embodiments of the present disclosure, the specified AID belongs to the reserved AID value. The reserved AID value indicates that the AID value currently belongs to the reserved value, and for devices conforming to published standards, the reserved value belongs to the unprocessed value.

In some embodiments, the protection method includes the encryption algorithm and/or the digest algorithm.

In some embodiments, the second information includes a specified AID and/or a disambiguation bit, wherein the specified AID in the second information is different from the specified AID in the first information. The specified AID in the second information belongs to the reserved AID value.

In some embodiments, the second information further includes a protected content field.

In some embodiments, the protected content field further includes an encrypted content field and/or a digested content field.

In some embodiments, the second information further includes a padding field and/or a scrambling field.

In some embodiments, the second information is acquired by uniformly processing M pieces of original information, wherein M is a positive integer.

In some embodiments, the second information is acquired by individually processing M pieces of original information, wherein M is a positive integer.

In some embodiments, the second information is acquired by processing part of the fields of M pieces of original information, wherein M is a positive integer.

In some embodiments, the first information further includes a partial protection information field. The partial protection information field is configured to indicate part of the fields in the original information that need to be protected.

In some embodiments, the control frame is a trigger frame. The second information in the trigger frame includes a protected user information User Info.

In some embodiments, the protected User Info in the trigger frame includes one protected User Info field. The protected User Info field is acquired by processing M original User Info fields, wherein M is a positive integer.

In some embodiments, the protected User Info in the trigger frame includes a plurality of protected User Info fields. Each of the protected User Info fields is acquired by processing one original User Info field.

In some embodiments, the protected User Info in the trigger frame includes a partially protected User Info field and an unprotected User Info field. The partially protected User Info field is acquired by processing part of the fields in M original User Info fields.

In some embodiments, a reserved AID value is included in the partially protected User Info field and the unprotected User Info field every other 5 bytes.

In some embodiments, a total length of a protected part in the trigger frame is ┌M1×k1÷5┐×5 bytes, wherein k1 represents a length of a processed result corresponding to the original User Info field, M1 represents the number of the original User Info fields, and both k1 and M1 are positive integers.

In some embodiments, a total length of a protected part in the trigger frame is ┌M1×k1÷5┐×5 bytes, wherein k1 represents a length of the processed result corresponding to part of the fields in the original User Info field, M1 represents the number of the original User Info fields, and both k1 and M1 are positive integers.

In some embodiments, in the case of individual encryption, the total length of the protected part in the trigger frame is also M1×(┌k1÷5 ┐×5) bytes.

In some embodiments, first 12 bits of the protected User Info in the trigger frame include at least two disambiguation bits.

In some embodiments, the disambiguation bits in the first 12 bits of the protected User Info in the trigger frame include an 11^{th} bit B10 and a 12^{th} bit B11, wherein a numerical value composed of B10 and B11 along with previous 10 bits of protected content is a reserved AID value.

In some embodiments, B10=0 and B11=1.

In some embodiments, the disambiguation bits in the first 12 bits of the protected User Info in the trigger frame include a 10^{th} bit B9, an 11^{th} bit B10, and a 12^{th} bit B11, wherein a numerical value composed of B9, B10, and B11 along with previous 9 bits of protected content is a reserved AID value.

In some embodiments, B9=0, B10=1, and B11=1.

In some embodiments, the control frame is an NDPA frame. The second information in the NDPA frame includes a protected station information (STA Info).

In some embodiments, the first information of the NDPA frame further includes a disambiguation bit.

In some embodiments, the protected STA Info in the NDPA frame includes one protected STA Info field. The protected STA Info field is acquired by processing M original STA Info fields, wherein M is a positive integer.

In some embodiments, the protected STA Info in the NDPA frame includes a plurality of protected STA Info fields. Each of the protected STA Info field is acquired by processing one original STA Info field.

In some embodiments, the protected STA Info in the NDPA frame includes a partially protected STA Info field and an unprotected STA Info field. The partially protected STA Info field is acquired by processing part of the fields in M original STA Info fields.

In some embodiments, the NDPA frame is a VHT NDPA frame.

In some embodiments, in the VHT NDPA frame, a reserved AID value is included in the partially protected STA Info field and the unprotected STA Info field every other 2 bytes.

In some embodiments, a total length of a protected part in the VHT NDPA frame is ┌M2×k2÷2┐×2 bytes, wherein k2 represents a length of a processed result corresponding to the original STA Info field, M2 represents the number of the original STA Info fields, and both k2 and M2 are positive integers.

In some embodiments, a total length of a protected part in the VHT NDPA frame is ┌M2×k2÷2┐×2 bytes, wherein k2 represents a length of a processed result corresponding to part of the fields in the original STA Info field, M2 represents the number of the original STA Info fields, and both k2 and M2 are positive integers.

In some embodiments, in the case of individual encryption, the total length of the protected part in the VHT NDPA frame is also M2×(┌k2÷2┐×2) bytes.

In some embodiments, in the VHT NDPA frame, the disambiguation bit in the first 12 bits of the protected STA Info is a 12^{th} bit B11.

In some embodiments, the NDPA frame is an HE NDPA frame, an EHT NDPA frame, or a ranging NDPA frame.

In some embodiments, in the HE NDPA frame, the EHT NDPA frame, or the Ranging NDPA frame, a reserved AID value is included in the partially protected STA Info field and the unprotected STA Info field every other 4 bytes.

In some embodiments, a total length of a protected part in the HE NDPA frame, the EHT NDPA frame or the ranging NDPA frame is ┌M3×k3÷4┐×4 bytes, wherein k3 represents a length of a processed result corresponding to the original STA Info field, M3 represents the number of the original STA Info fields, and both k3 and M3 are positive integers.

In some embodiments, a total length of a protected part in the HE NDPA frame, the EHT NDPA frame or the ranging NDPA frame is ┌M3×k3÷4┐×4 bytes, wherein k3 represents a length of a processed result corresponding to part of the fields in the original STA Info field, M3 represents the number of the original STA Info fields, and both k3 and M3 are positive integers.

In some embodiments, in the case of individual encryption, the total length of the protected part in the HE NDPA frame, the EHT NDPA frame or the ranging NDPA frame is also M3×(┌k3÷4┐×4) bytes.

In some embodiments, in the HE NDPA frame, the EHT NDPA frame or the ranging NDPA frame, the disambiguation bit in first 28 bits of the protected STA Info is a 28^{th} bit B27.

A specific example of the method 300 performed by the second station in the embodiments can refer to the relevant descriptions regarding the second station in the above method 200. For brevity, details are not repeated here. In the embodiments, the security of communication between stations is improved by protecting the information in the control frame transmitted between stations, such as the control frame transmitted by the second STA to the first STA.

Control frames include a trigger frame and an NDPA frame. In the case that frame bodies of the trigger frame and/or NDPA frame are not encrypted, information leakage may occur. For example, a User Info field in the trigger frame might reveal a user's AID, which could then expose a mapping relationship between the AID and MAC address. After association, in the case that the MAC address of an STA address undergoes randomization without requiring re-association, its new MAC address would be directly exposed by the AID. Additionally, by eavesdropping on RU, a behavioral pattern of a service may be revealed by the AID and modulation-demodulation information, such as determining whether a user is within a specific area or engaged in traffic-consuming services. For another example, an STA Info field in an NDPA frame may reveal users' AIDs and other information, thus leaking the mapping relationship between the AID and MAC addresses. In the embodiments of the present disclosure, the trigger frame and the NDPA frame are modified, with specific details provided in the following descriptions.

### 1. Process for Trigger Frame and NDPA Frame Protection Mechanisms

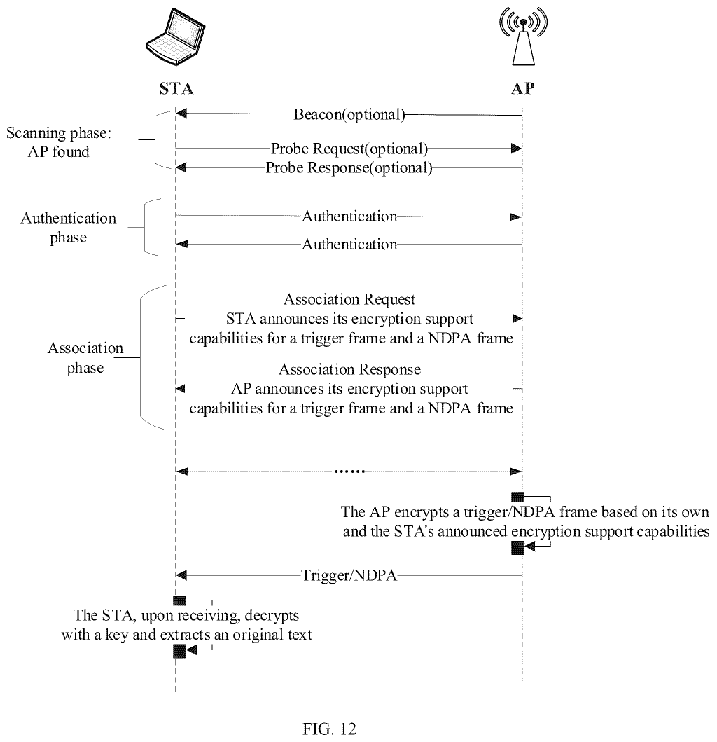

In the case that the frame bodies of both the trigger frame and the NDPA frame are not encrypted, the User Info field in the trigger frame may reveal information such as a user's AID and a behavioral pattern of a service; and the STA Info field in the NDPA frame may reveal information such as a user's AID. In some embodiments, STA stands for non-AP STA, and AP stands for AP STA. As shown in FIG. 12, the process for the encryption protection mechanism of the trigger frame and/or the NDPA frame according to the embodiments of the present disclosure includes:
(1) Scanning phase and authentication phase: The process in the phases remains unmodified. Alternatively, the process in these phases are modified such that the STA and the AP announce their support capabilities for the encryption mechanisms of the trigger frame and/or the NDPA frame by authentication frames.
(2) Association phase: When transmitting an association request, the STA announces its support capabilities for the encryption mechanism of the trigger frame and/or the NDPA frame by a newly added encryption capability information element to the AP. Subsequently, the AP also announces its support capabilities for the encryption mechanism of the trigger frame and/or the NDPA frame to the STA by a newly added encryption capability information element.
(3) Afterwards, in the case that the AP needs to transmit the trigger frame and/or the NDPA frame to the STA, the AP needs to encrypt the trigger frame and/or the NDPA frame based on the capabilities announced by both itself and the STA. The STA then decrypts an encrypted trigger frame and/or NDPA frame received using a key.

The present disclosure does not limit a type of encryption technology; it can use symmetric encryption (such as AES128, AES192, AES256) and/or asymmetric encryption (such as ECC p256, ECC p384) to encrypt the trigger frame and the NDPA frame. The only requirement is that the AP and STA complete the corresponding key exchange prior to transmitting the trigger frame and/or the NDPA frame.

In some embodiments, a digest protection mechanism for the trigger frame and/or the NDPA frame is also provided in the present disclosure. For example, using the digestion method, the STA receiving the information needs to use its own known information (such as the STA's own AID) to perform digestion by using the same algorithm as the transmitter. A generated digest is then compared with the digest in each received User Info/STA Info. In the case that the two digests are consistent, the User Info/STA Info related information indicated by the digest is intended for the STA. In the case that the two digests are not consistent, the digest in the received User Info/STA Info is ignored.

In some embodiments, a digest encryption protection mechanism for the trigger frame and/or the NDPA frame is provided in the present disclosure.

For example, the method used involves both digestion and encryption (e.g., HMAC, CBC-MAC, or GMAC). Different from the encryption-only method, the STA receiving the information needs to use its own known information (e.g., AID of the STA) to perform digestion and encryption by using the same algorithm as the transmitter. A generated ciphertext is compared with the ciphertext in each received User Info/STA Info. In the case that they the two ciphertexts are consistent, the User Info/STA Info related information indicated by the ciphertext is intended for the STA. In the case that the two ciphertexts are not consistent, the ciphertext in the received User Info/STA Info is ignored.

### 2. Frame Format for Trigger Frame and NDPA Frame Protection Mechanisms

The present disclosure achieves protection for the trigger frame and the NDPA frame by adding encryption-related information fields to an association request frame, an association response frame, a trigger frame and an NDPA frame. In the examples, the addition of encryption-related information fields is taken as an example for illustration; and digestion-related fields can also be added following a similar principle.

### 2.1 Association Request Frame and Association Response Frame

During the association phase, the STA announces its encryption support capabilities for the trigger frame and/or the NDPA frame by using the association request frame. The AP announces its encryption support capabilities for the trigger frame and/or the NDPA frame by using the association response frame. Additionally, during the authentication phase, the STA and AP announce their encryption support capabilities for the trigger frame and/or the NDPA frame by using the authentication frame, respectively. In the embodiments, the modification of the association request and/or association response frames is taken as an example for illustration. The modification method for announcing encryption support capabilities in the authentication frame can refer to the method used in the association request frame and/or the association response frame.

### 2.1.1 Example 1

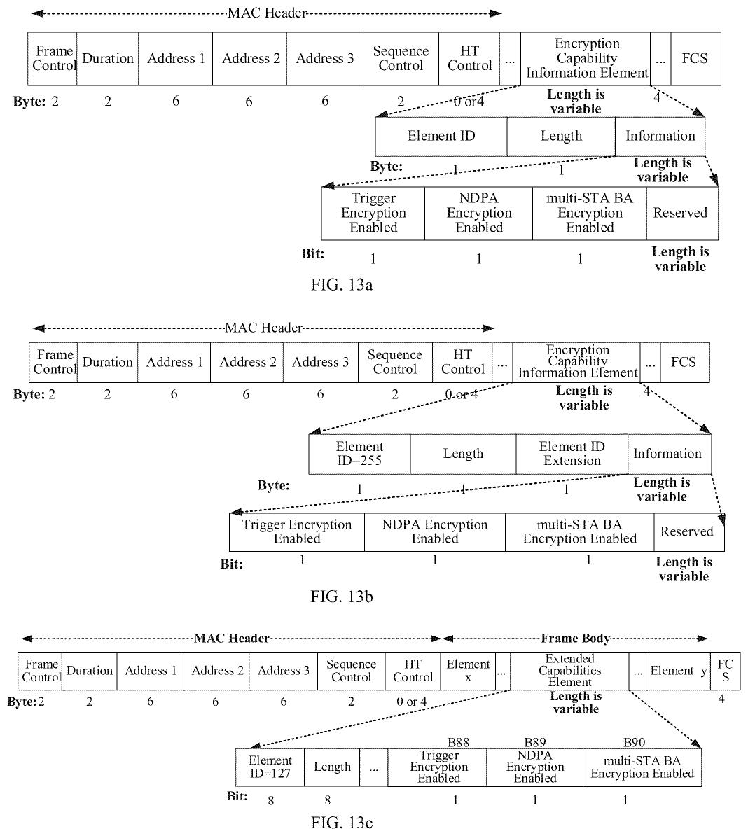

In the association request frame and/or association response frame, a new encryption capability information element is added. In the case that the association request frame and/or the association response frame do not include the element, the STA/AP does not support encryption of the control frame. As shown in FIG. 13a, a reserved element ID value is utilized by an element identifier (Element ID) of the encryption capability information element, wherein the Element ID could be any value in the, for example, following range: 2/4/8/9/17-31/47/49/77/103/128-129/133-136/149-150/155-156/165/173/176/178-180/203/218-219/227/238/243/245-254. Alternatively, as shown in FIG. 13b, a reserved element extension ID value is utilized by the encryption capability information element. For example, the Element ID field is 255, with only a value of an Element ID Extension field changed, such as 0/32/35-39/41-43/45-51/55/57-87/94-255.

An Information field of the encryption capability information element includes one or more encryption capability fields for the control frame. For example, the Information field includes a trigger frame encryption capability (Trigger Encryption Enabled), an NDPA frame encryption capability (NDPA Encryption Enabled) and a multi-STA BA frame encryption capability (multi-STA BA Encryption Enabled). These fields are configured to announce the STA/AP's encryption support capabilities for the three types of frames, respectively; and the Reserved field is configured for storing a key or other information. Additionally, as seen in FIG. 13a and FIG. 13b, the association request frame and/or association response frame further include fields such as Frame Control, Duration, Address 1, Address 2, Address 3, Sequence Control, High Throughput (HT) Control and FCS.

### 2.1.2 Example 2

One or more encryption capability fields for the control frame are added to an Extended Capability Element of the association request frame and/or the association response frame. For example, it includes a trigger frame encryption capability (Trigger Encryption Enabled), an NDPA frame encryption capability (NDPA Encryption Enabled) and a multi-STA BA frame encryption capability (Multi-STA BA Encryption Enabled). STA and AP can announce their encryption support capabilities for the three types of frames. The selection of the three fields can use any reserved bits, such as B5, B35, B59, B76-B79, B83, B86, B88-Bn or a new bit. In FIG. 13c, the selection of B88, B89 and B90 is taken as an example for illustration.

### 2.2 Encryption and Frame of Trigger Frame

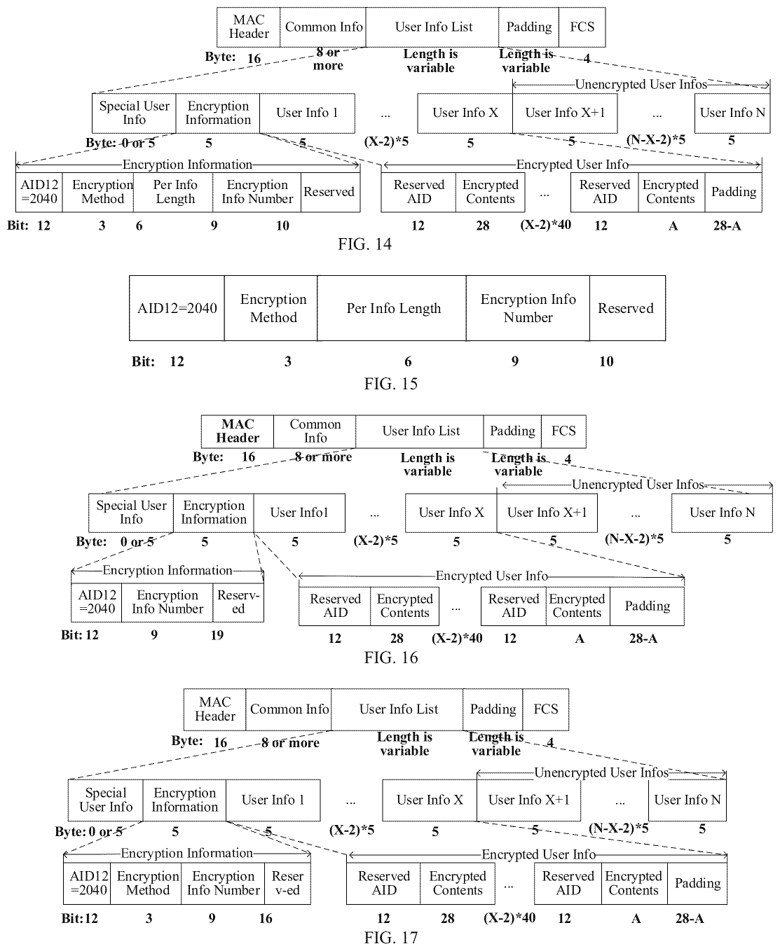

After the AP encrypts the trigger frame using encryption technology, it needs to consider the compatibility of the trigger frame with legacy STAs (Legacy-STAs). The present disclosure mainly modifies the frame body of the trigger frame. The specific frame format of the trigger frame after encryption is shown in FIG. 14.

For example, the User Info List field of the trigger frame includes Encryption Information. The Encryption Information field is configured to assist STAs in decryption by announcing the encryption information of the protected User Info. The User Info List field further includes an Encrypted User Info field. The Encrypted User Info field includes fields from User Info 1 to User Info X. The Encrypted User Info field carries ciphertext information of the encrypted User Info. In the case of using the unified encryption method, there is only one Encrypted User Info field. This is because unencrypted M User Info fields (i.e., the original User Info fields) are encrypted to produce one Encrypted User Info field, which actually occupies a length of X User Info fields. In the case of using the independent encryption method, there are one or more Encrypted User Info fields. This is because the unencrypted M User Info fields (i.e., the original User Info fields) are encrypted to produce M Encrypted User Info fields, which actually occupy a length of Y×M User Info fields. The fields from User Info X+1 to User Info N include several remaining unencrypted User Info fields, such as User Info fields with AID=0/2007/2045/2046 and 4095, and User Info fields transmitted to STAs that do not support trigger frame encryption function.

FIG. 15 illustrates an example of the Encryption Information field.

For example, the AP announces encryption information using a reserved AID value (such as 2040 or any value between 2008-2044/2047-4094). The Encryption Information field includes the encryption method (Encryption Method), the corresponding length for each piece of information and the number of original user information protected by encryption. The corresponding length for each piece of information (Per Info Length) is denoted as k and is based on a unit of 5 bytes. The number of original user information encrypted is abbreviated as the Encryption Info Number, denoted as M, with 5×k×M (bytes) equaling a total length of all encrypted parts.

In the case of unified encryption (and partial encryption), k is taken to represent a length of the original text that needs to be encrypted, measured in bytes. In the case of unified encryption (and full encryption), k is unnecessary. In the case of individual encryption, k is taken to represent a ciphertext length corresponding to each piece of original user information (User Info).

Legacy-STAs will skip the User Info as they are unable to identify the reserved AID value. New version STAs, such as the first STA in the above embodiments, can identify the User Info (with a 5-byte structure) as the User Info carrying encryption information, and then acquire related encrypted contents (Encrypted Contents) following the AID field. In the case that the encryption method is known, the encryption information only needs to include the number of original User Infos protected by encryption (M), with the specific frame format as shown in FIG. 16.

In the case that the AP performs unified encryption, the encryption information only needs to include the encryption method and the number of original User Info encrypted (M), with the specific frame format as shown in FIG. 17.

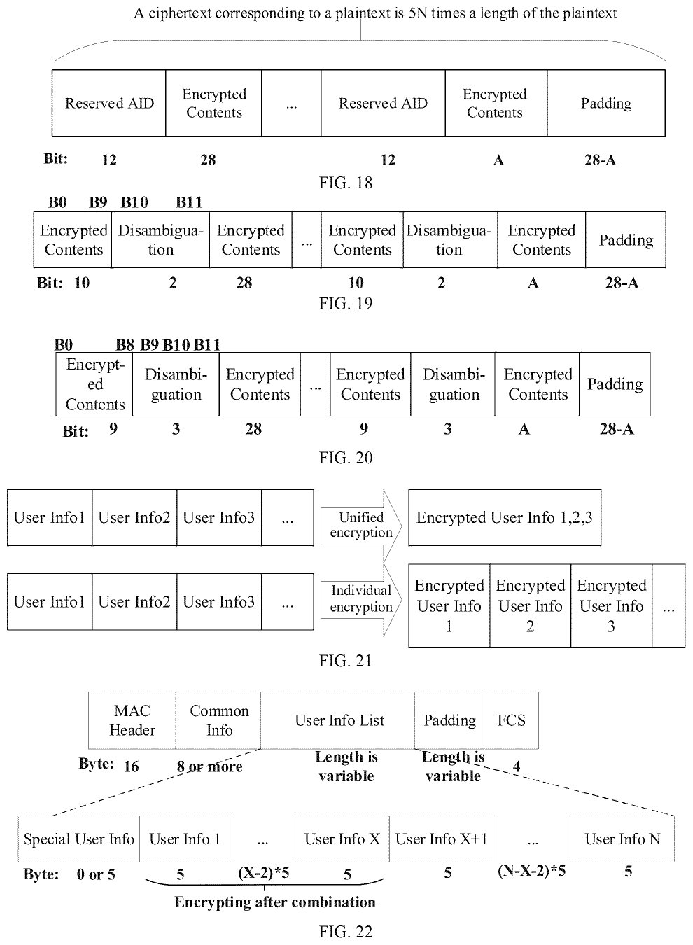

The ciphertext field is the Encrypted User Info field, which includes fields from User Info 1 to User Info X. The original User Info before encryption is plaintext, and the User Info after encryption is ciphertext. A length of the ciphertext corresponding to the plaintext is 5 N times a length of the plaintext, as seen in FIG. 18. Considering compatibility with Legacy-STAs, the Encrypted User Info field is implemented using a reserved AID value and/or several bits of disambiguation. In the Encrypted User Info field, the reserved AID value can be, for example, 2040, 2046 or any value between 2008-2042/2047-4094, different from the reserved value used in the aforementioned encryption information field.

Legacy-STAs sequentially read first 12 bits of every 5 bytes in the Encrypted User Info field, potentially acquiring the reserved AID (Reserved AID) value. Since the reserved AID value does not correspond to AIDs in a range of 1-2007, Legacy-STAs skip 28 bits of encrypted contents that immediately follow. However, new version STAs can identify the reserved AID value, thus will receive and store the ciphertext following the reserved AID value (e.g., Encrypted Contents field), and then decrypt it upon completing the reception of the ciphertext.

To ensure Legacy-STAs can receive and read in units of 5 bytes, any ciphertext less than 5 bytes needs to be padded. During decryption, STAs calculate an end position of the ciphertext based on the information in the Encryption Information field, and ignore the subsequent padding fields.

In another example, the first 12 bits of every 5 bytes in the Encrypted User Info field have two or more bits fixed for disambiguation processing. As shown in FIG. 19, two bits are fixed as Disambiguation, with B10 set to 0 and B11 set to 1. In this case, Legacy-STAs identify, from the first 12 bits of every 5 bytes in the Encrypted User Info field, that the AID is between 2048 to 3071, which belongs to the reserved AID values, and will ignore the 28 bits of encrypted contents that immediately follow.

As shown in FIG. 20, three bits are fixed as Disambiguation, with B9 set to 0, B10 set to 1 and B11 set to 1. In this case, Legacy-STAs identify, from the Encrypted User Info field, that the AID is between 3072 to 3583, which belongs to the reserved AID values, and will ignore the 28 bits of encrypted contents that immediately follow. The process continues in this manner. New version STAs will receive and store the ciphertext (Encrypted Contents field) before and after Disambiguation, and then decrypt it upon completing the reception of the ciphertext. In the case that the ciphertext is less than 5 bytes, padding is required.

As shown in FIG. 21, various encryption methods are provided according to the present disclosure, such as unified encryption and individual encryption. Unified encryption involves combining a plurality of User Infos prior to encrypting them. In this case, a key shared among all STAs is utilized, such as the Temporal Key (TK) commonly utilized for encrypting multicast data in GTK. Individual encryption involves encrypting each User Info separately. In this case, different keys for each STA are utilized, such as the Temporal Key (TK) commonly utilized for encrypting unicast data in PTK. Considering the encryption method's requirement for the minimum encryption length and the limitation of Legacy-STAs' compatibility with encrypted trigger frames, the unified encryption method can reduce overhead. However, due to the shared key, confidentiality of the unified encryption method is limited. In the individual encryption method, each User Info is encrypted with a different key, offering strong confidentiality, but it may generate more redundancy.

Unified encryption is taken as an example, as shown in FIG. 22. First, a plurality of User Info fields are combined. In the case that combined data does not meet a length requirement for input data of the encryption algorithm, padding is required. Then, encryption is performed using the unified encryption method. To ensure compatibility with Legacy-STAs, a length of an encrypted field needs to be an integer multiple of 5. In the case that a ciphertext length after encryption is not an integer multiple of 5, a small number of redundant bytes need to be added for padding. In the case of using individual encryption, each encrypted User Info needs to be padded with redundant bytes where a length after encryption is insufficient.

### 2.2.1 Example 1: Achieving Compatibility Using Reserved AID

Compatibility with Legacy-STAs is achieved by using a reserved AID. In the case that the encryption is performed using the unified encryption method, there is only one Encrypted User Info (i.e., fields from User Info 1 to User Info X) in the user information list (User Info List) of the trigger frame. The frame structure of a unified encryption trigger frame that achieves compatibility using a reserved AID can be seen in FIG. 17. In the case of unified encryption, the encryption information includes the encryption method and the number of original user information that needs to be encrypted (e.g., Encryption Info Number field).

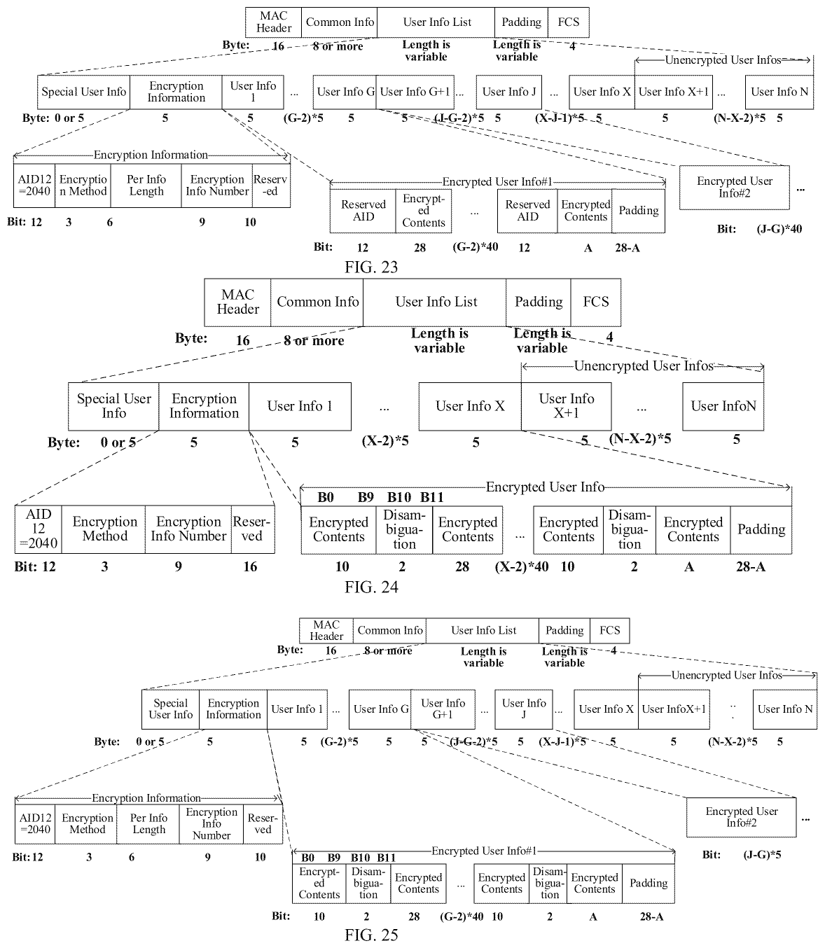

In the case that the encryption is performed using the individual encryption method, there is one or more Encrypted User Infos in the User Info List of the trigger frame. The specific number of Encrypted User Infos is determined by the number of original User Infos that need to be encrypted individually, with the frame structure shown in FIG. 23. In the case of individual encryption, the encryption information includes the encryption method, the number of original user information that needs to be encrypted (e.g., Encryption Info Number field) and the corresponding length for each piece of information (e.g., Per Info Length field).

### 2.2.2 Example 2: Achieving Compatibility Using Two-Bit or Three-Bit Fixed Value as Disambiguation

Compatibility with Legacy-STAs is achieved by using two-bit fixed values as the Disambiguation bits. In the case that the encryption is performed using the unified encryption method, there is one Encrypted User Info (i.e., fields from User Info 1 to User Info X) in the User Info List of the trigger frame. Using a two-bit fixed value as Disambiguation as an example, a frame structure of the trigger frame is shown in FIG. 24.

In the case of using the individual encryption method, there is one or more Encrypted User Infos in the User Info List, with the specific number of Encrypted User Infos determined by the number of original User Infos that need to be encrypted individually. In this case, the frame structure of the trigger frame is shown in FIG. 25, which includes a plurality of encrypted user information, such as Encrypted User Info #1 and Encrypted User Info #2. The Encrypted User Info #1 includes fields from User Info 1 to User Info G, and the Encrypted User Info #2 includes fields from User Info G+1 to User Info J.

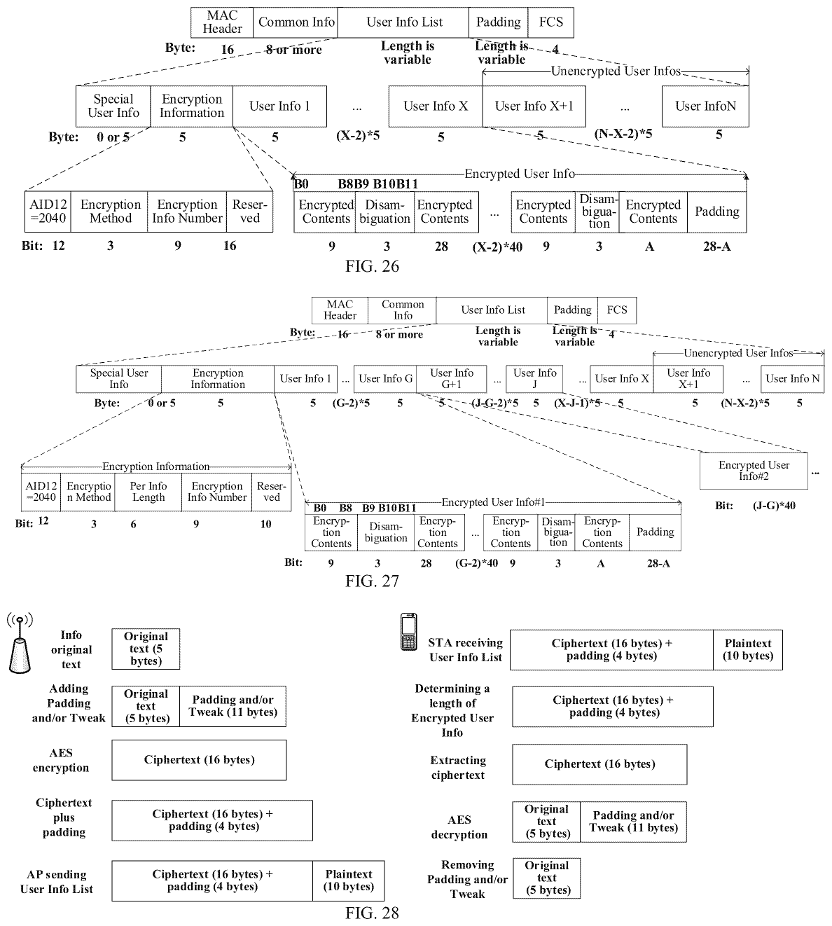

Compatibility with Legacy-STAs is achieved by using three-bit fixed values as the Disambiguation bits. In the case that the encryption is performed using the unified encryption method, there is one Encrypted User Info (i.e., fields from User Info 1 to User Info X) in the User Info List of the trigger frame. Using a three-bit fixed value as Disambiguation as an example, the frame structure of the trigger frame is shown in FIG. 26.

In the case of using the individual encryption method, there is one or more Encrypted User Infos in the User Info List of the trigger frame (each Encrypted User Info corresponding to one User Info), with the specific number of Encrypted User Infos determined by the number of individually encrypted User Infos. In this case, the frame format and structure of the trigger frame are shown in FIG. 27.

### 2.2.3 Trigger Frame Encryption and Decryption Process

After the AP encrypts the trigger frame using encryption technology, it still needs to consider the compatibility of the trigger frame with Legacy-STAs. Therefore, to ensure that Legacy-STAs can correctly receive and read the trigger frame, fields that do not meet the length requirement are subjected to Padding (data padding) or Tweak (random data scrambling) for padding. Padding refers to redundant padding, and Tweak refers to random scrambling, which enhances the protection of the ciphertext. During decryption, STAs calculate the end position of the ciphertext based on the information in the Encryption Information field, such that the corresponding Padding and Tweak fields are ignored and the complete information field is acquired. The present disclosure takes the AES128 encryption algorithm as an example to perform padding and/or random scrambling (Tweak) on the trigger frame, with a specific process shown in FIG. 28.

Using FIG. 28 as an example, main processing processes on the AP side include: in the case that the User Info original text field of the trigger frame is not an integer multiple of 16 bytes, the original text is first increased with padding and/or random scrambling (Tweak) to the corresponding length, and then the AES128 symmetric encryption is performed using TK as the key. To ensure compatibility of the trigger frame with Legacy-STAs, the trigger frame also needs to be padded such that the length of the trigger frame is an integer multiple of 5, that is, 20 bytes, plus 10 bytes of plaintext of unencrypted User Info, making a length of the User Info List transmitted by the AP 30 bytes.

On a receiving STA side, the main processing processes include:
(1) Distinguishing ciphertext from plaintext: using FIG. 28 as an example, upon receiving the 30-byte User Info List (ciphertext+plaintext) transmitted by the AP, the STA acquires the number of original User Infos encrypted (M=1) by Encryption Information→Encrypted Info Number (see FIG. 14), and determines the length of the original User Info after encryption (k=4, with 5 bytes as a base unit of measurement) by Encryption Information→Per Info Length (see FIG. 14). Since one User Info occupies 5 bytes, it is determined that a ciphertext field length is M×k×5 (1×4×5=20) bytes. Since the first 20 bytes are ciphertext, the remaining 10 bytes are plaintext.
(2) Determining a valid ciphertext field length: since an encrypted ciphertext field is padded to an integer multiple of 5 bytes, upon determining the ciphertext length, it is also necessary to determine the valid ciphertext length. The method involves determining the encryption method as AES128 encryption by Encryption Information→Encryption Method (see FIG. 14), determining the encrypted ciphertext length to be 16 bytes, then extracting, by the STA, the first 16 bytes of ciphertext information and ignoring the last 4 bytes of padding. A decrypted plaintext is acquired by decrypting the ciphertext using the key.
(3) Extracting valid plaintext information: since the plaintext, after the decryption in process (2), has a padding field or a scrambling field (e.g., Padding field and Tweak field), the STA needs to further extract the valid plaintext. The extraction method involves determining that the frame is a trigger frame based on Type field and SubType field in MAC Header (FIG. 14), thus determining that the valid User info length is 5 bytes. In FIG. 28, since the Padding field and the Tweak field are placed at the end, the first 5 bytes of the decrypted plaintext are extracted as the valid User Info, and the last 11 bytes are ignored. The Padding field and the Tweak field are placed at the front or the back, as agreed upon in specific implementations, with FIG. 28 illustrating an example with the Padding field and/or the Tweak field at the back.

### 2.3 Encryption and Frame of NDPA Frame

NDPA frames have four subtypes, including VHT/HE/EHT/ranging NDPA frames. The frame format of each of the NDPA frame types varies and is designed based on its category.

The VHT NDPA frame includes a S1G type and a non-S1G type. The present disclosure primarily takes the non-S1G VHT NDPA frame as an example for illustration, with a principle of the S1G VHT NDPA frame referencing a principle of the non-S1G VHT NDPA frame.

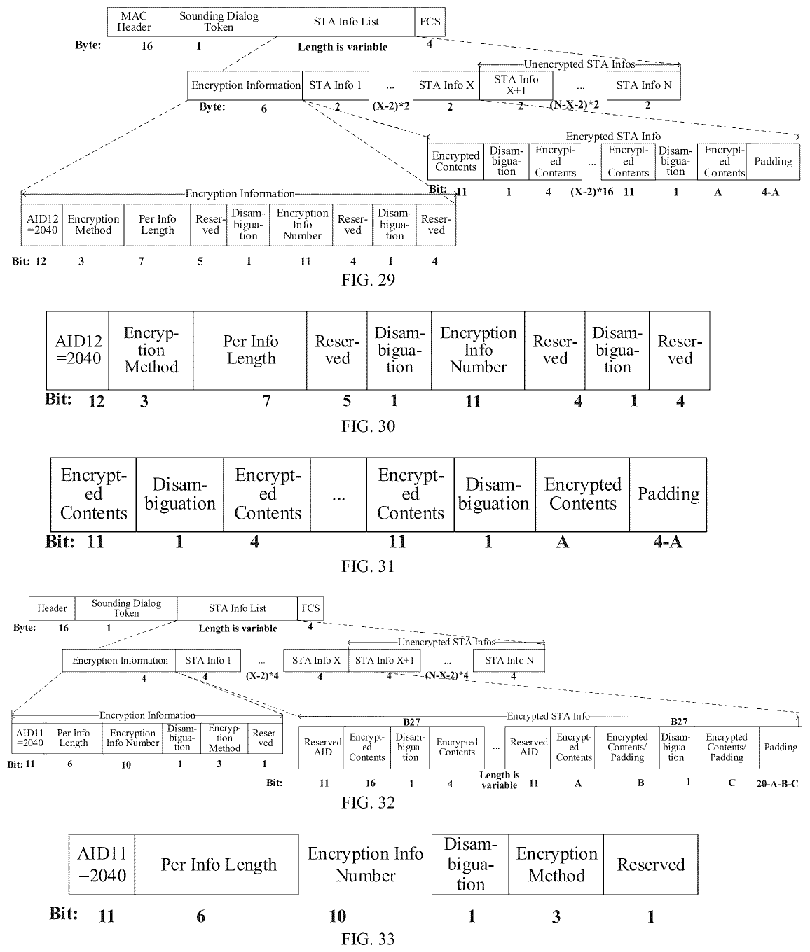

The specific frame format of non-S1G VHT NDPA after encryption is shown in FIG. 29.

The Encryption Information field assists STAs in decryption by announcing the encryption information of the STA Info field. The Encrypted STA Info field (i.e., fields from STA Info 1 to STA Info X) carries ciphertext information of the encrypted STA Info. Fields from STA Info X+1 to STA Info N are several remaining unencrypted STA Infos, such as User Info with AID=0−2007/2043-2045/4095 and STA Info from the STA that does not support encryption of NDPA frame.

The encryption information field of VHT non-S1G STA NDPA is shown in FIG. 30.

The AP announces the encryption information using a reserved AID value, such as 2040, with a usable AID range being 2008-2042 and 2046. The encryption information includes the encryption method, a ciphertext length per STA Info (k) and the number of original STA Infos encrypted (M). The total length of all encrypted parts equals 2B×k×M.

Legacy-STAs read first 12 bits in units of two bytes. In the case that the Disambiguation field value is 1, the legacy-STAs cannot identify the AID and will skip the following four bits. However, new version STAs may identify the STA Info (with a 2-byte structure) as the STA Info carrying the encryption information and continue to read related encryption information. In the case that the encryption method is known, the encryption information only needs to include the number of original STA Infos encrypted (M).

The design of ciphertext fields, such as the encrypted station information (Encrypted STA Info) field, considers compatibility with Legacy-STAs. For example, compatibility is achieved by setting a 1-bit Disambiguation bit, as shown in FIG. 31, where the disambiguation bit B11=1 is set at a 12^{th} bit.

Legacy-STAs read first 12 bits of the encrypted station information in units of two bytes, with Disambiguation read as 1. Since they cannot correspond to the AID within the range of 1-2007, Legacy-STAs skip the following four bits. New version STAs may receive and store the ciphertext (Encrypted Contents field) before and after the Disambiguation field, and then decrypt the ciphertext upon completing the reception of the ciphertext information.

To ensure Legacy-STAs can receive and read in units of two bytes, any ciphertext less than two bytes needs to be padded. During decryption, STAs calculate the end position of the ciphertext based on the information in the Encryption Information field and ignore the subsequent Padding fields.

The specific frame format of HE/EHT/ranging NDPA after encryption is shown in FIG. 32. The encryption information field of HE/EHT/ranging NDPA is shown in FIG. 33.

The AP announces the encryption information using a reserved AID=2040, with a usable AID range being 2008-2042 and 2046. The encryption information includes the ciphertext length per STA Info (k), the number of original STA Infos encrypted (M) and the encryption method. The total length of all encrypted parts equals 4×k×M bytes.

Legacy-STAs cannot identify the AID and will skip the STA Info. New version STAs can identify the STA Info as the STA Info carrying the encryption information and continue to read related encryption information. In the case that the encryption method is known, the encryption information only needs to include the total number of STA Infos encrypted (M).

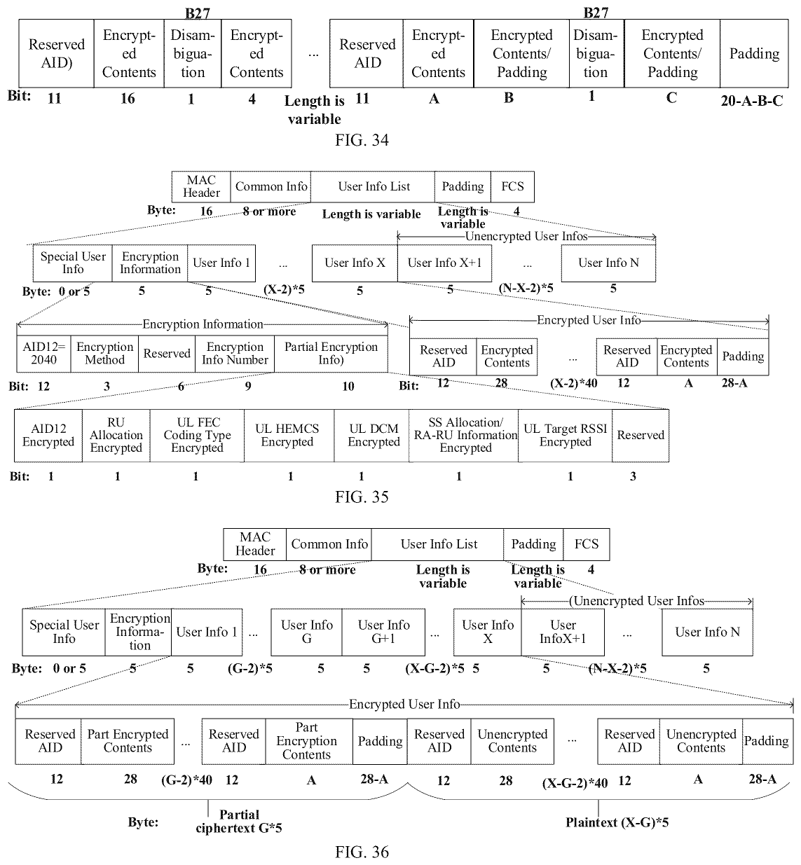

The design of ciphertext fields, such as the encrypted station information (Encrypted STA Info) field, considers compatibility with Legacy-STAs. For example, compatibility is achieved by setting a reserved AID. Additionally, to accommodate the standards for setting HE/EHT/ranging NDPA frame formats (as shown in FIG. 7 to FIG. 9), the STA Info of the frames needs to set one bit of Disambiguation at the B27 bit, as shown in FIG. 34.

Legacy-STAs read first 11 bits in units of four bytes, and since the legacy-STAs cannot correspond to AIDs within a range of 1-2007, the Legacy-STAs skip the following 21 bits. New version STAs will receive and store the ciphertext (Encrypted Contents field) after a reserved AID field, and then decrypt ciphertext information upon completing the reception of the ciphertext information.

To ensure Legacy-STAs can receive and read in units of 4 bytes, any ciphertext less than 4 bytes needs to be padded. During decryption, STAs calculate the end position of the ciphertext based on the information in the Encryption Information field and ignore the subsequent Padding fields.

The embodiments of the present disclosure achieve the following beneficial effects:

The frame bodies of the trigger frame and the NDPA frame carry personal correlation information (PCI), such as AID, which involves user privacy. Since the frame bodies are not encrypted, information such as the mapping relationship between user AID and MAC addresses may be leaked. The present disclosure proposes an encryption protection mechanism for the trigger frame and the NDPA frame, which achieves the announcement of the STA/AP encryption capabilities by modifying the association request/response frames and achieves the protection of privacy information and compatibility with Legacy-STAs by modifying the trigger frame and NDPA frame.

Since some encryption methods may have limitations on the minimum encryption length, and there are specific requirements for frame length regarding compatibility, the present disclosure further proposes a method for unified encryption of User/STA Info to reduce the redundancy of encryption and decrease the occupancy of channel resources.

Additionally, the present disclosure further proposes a technical extension method for partial encryption. Using partial encryption can improve encryption flexibility, allowing for the selective protection of fields that need protection. Compared with the unified encryption method, this method reduces overhead to a greater extent and promotes the rational use of resources.

### 3. Partial Encryption Protection Mechanism for Trigger Frame and NDPA Frame

Using the basic solutions of the present disclosure, in practical implementation, different encryption methods can be utilized to protect user privacy information based on varying requirements, allowing the solutions to adapt to other needs. According to the technical solutions and inventive concept of the present disclosure, equivalent substitutions and changes are considered within protection scope of claims of the present disclosure.

The aforementioned unified encryption and individual encryption methods can encrypt all fields of the information that need to be encrypted in the trigger frame and/or the NDPA frame. In addition, the partial encryption method can be utilized to protect the trigger frame and/or the NDPA frame. In the partial encryption method, part of the fields of the information that need to be encrypted in the trigger frame and/or the NDPA frame are encrypted.

For the protection mechanism of the trigger frame and the NDPA frame, a partial encryption method is utilized for fields at risk of information leakage. Partial encryption not only enhances encryption flexibility but also reduces overhead. Partial encryption demonstrates significant advantages during a unified encryption. The following descriptions of partial encryption will use unified encryption as an example. The principle of partial encryption in individual encryption can refer to a principle of partial encryption in unified encryption.

Firstly, the partial encryption method is introduced using an HE trigger frame as an example. FIG. 35 illustrates an example of the encryption information field of an HE trigger frame using the partial encryption method.

In the partial encryption method, within the Encryption Information field of the HE trigger frame, a Partial Encryption Info field is added to indicate which fields are encrypted.

The fully encrypted Encrypted User Info field only carries the ciphertext of all encrypted User Info. In the partial encryption method, the Encrypted User Info field includes a ciphertext corresponding to part of the information in the original user information and a plaintext of part of the information in the original user information.

The specific frame format of the HE trigger frame is shown in FIG. 36. Upon processing the HE trigger frame with the partial encryption method, the acquired Encrypted User Info (encrypted to be X×5 bytes) consists of two parts, which are the partially encrypted ciphertext (referred to as partial ciphertext, for example, including G×5 bytes) and the unencrypted plaintext (e.g., including (X−G)×5 bytes). In the case that encryption protection is needed, the AP performs unified encryption on the parts of the User Info that need to be encrypted. The encrypted ciphertext is placed in the Partial Encrypted Contents and padded to an integer multiple of 5, and the unencrypted plaintext parts are placed in the Unencrypted Contents in the original User Info order. The new version STA performs decryption after reception. Since it is known which parts are encrypted, the original User Info can be reassembled in order upon decrypting the ciphertext field.

The following takes encrypting AID12 and SS Allocation/RA-RU Information as an example. Firstly, when transmitting the trigger frame, the AP sets the bits corresponding to AID12 Encrypted and SS Allocation/RA-RU Information Encrypted in the Partial Encryption Info field to 1, and sets the rest to 0. When receiving the partially encrypted trigger frame, the STA knows from the encryption information field that AID12 and SS Allocation/RA-RU Information are encrypted. The STA decrypts the Partial Encrypted Contents field and acquires all AID12 and SS Allocation/RA-RU Information arranged in the order of the encrypted User Info. In this case, since the plaintext information in the subsequent plaintext fields is also arranged in the corresponding field order in the frame format and the order of the encrypted User Info, the original text can be restored by inserting AID12 and SS Allocation/RA-RU Information in the order of the frame format into the plaintext fields.

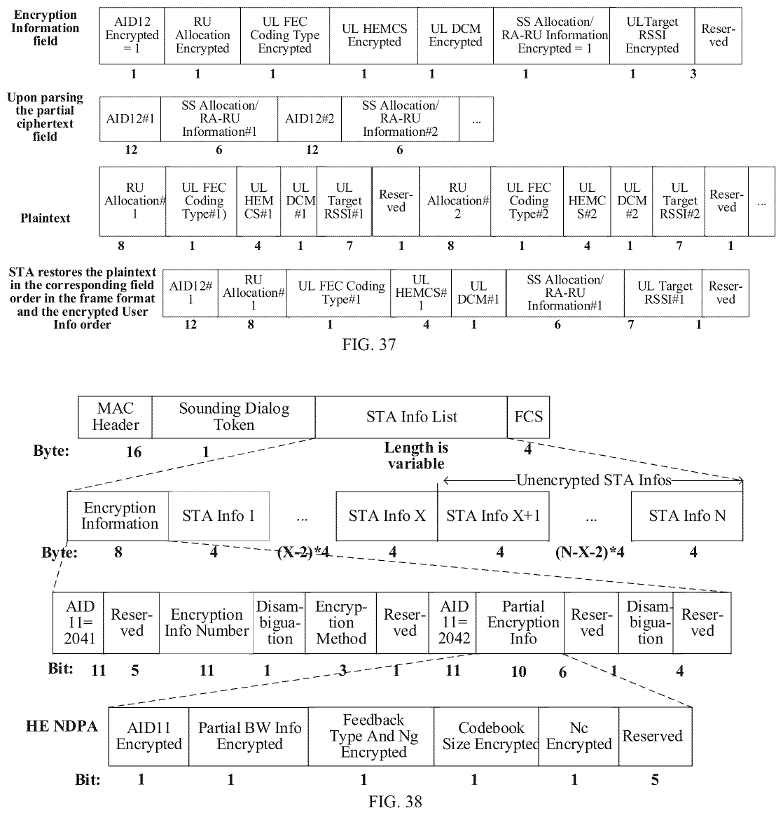

For example, referring to FIG. 37, upon parsing the partial ciphertext field, the following fields are acquired in sequence: AID12 #1, SS Allocation/RA-RU Information #1, AID12 #2, SS Allocation/RA-RU Information #2, and the like. Following the frame format of the HE trigger frame, AID12 #1 is inserted in first 12 bits of the first plaintext segment, moving other fields starting from a 13^{th} bit of the first plaintext segment backwards; then, SS Allocation/RA-RU Information #1 is inserted between a 27^{th} bit and a 32^{nd} bit of the first plaintext segment, moving other fields starting from a 33^{rd} bit of the first plaintext segment backwards. Using a similar method, AID12 #2 and SS Allocation/RA-RU Information #2 are inserted into the second plaintext segment, and so on, until all decrypted AID12 and SS Allocation/RA-RU Information are inserted to complete the restoration.

It should be noted that to ensure compatibility with Legacy-STAs, the two field parts of ciphertext and plaintext within the Encrypted User Info field are disambiguated every other 5 bytes using a reserved AID value.

The EHT trigger frame has a structure similar to a structure of the HE trigger frame, with the ciphertext field and the plaintext field being consistent with HE. There are only minor differences in the naming of certain fields within the encryption information field. The present disclosure will not elaborate further on the encryption information field for the EHT trigger frame using the partial encryption method.

The partial encryption frame formats of HE/EHT/ranging NDPA frames are introduced separately below. In the Encryption Information field, an additional Partial Encryption Info field is added, wherein the Partial Encryption Info field is configured to indicate which fields are encrypted. The fields needing protection in HE/EHT/ranging NDPA frames vary slightly and are introduced separately below.

As shown in FIG. 38, in the partial encryption frame format of the HE NDPA frame, the Partial Encryption Info field within the Encryption Information field includes the following fields: AID11 Encrypted, Partial BW Info Encrypted, Feedback Type and Ng Encrypted, Codebook Size Encrypted, Nc Encrypted and Reserved. These fields indicating partial encryption are specified by 1 bit to indicate which fields of the HE NDPA frame are partially encrypted.

The use of partial encryption requires the indication of specific fields to be encrypted. Therefore, HE/EHT/ranging NDPA frames all require eight bytes of Encryption Information. To enable the receiver to distinguish between full encryption (which requires four bytes of Encryption Information) and partial encryption, the Reserved AID utilized here can be different from the AID utilized for full encryption, thereby informing the STA that the Encryption Information is eight bytes. For example, AID11=2041. The subsequent four bytes of Reserved AID utilized for disambiguation should also be differentiated from the previously mentioned AID, for example, AID11=2042. Legacy-STAs sequentially read first 11 bits of every other 4 bytes, and upon reading AID=2041 and/or AID11=2042, since they cannot correspond to an AID within a range of 1-2007, they skip following 21 bits of information.

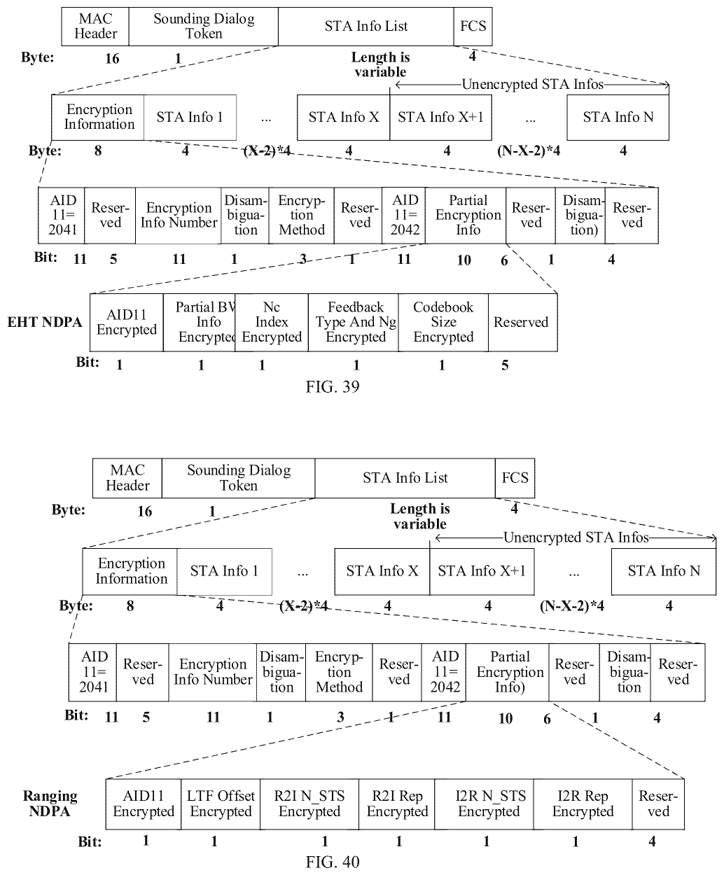

As shown in FIG. 39, in the partial encryption frame format of the EHT NDPA frame, the Partial Encryption Info field within the Encryption Information field includes the following fields: AID11 Encrypted, Partial BW Info Encrypted, Nc Index Encrypted, Feedback Type and Ng Encrypted, Codebook Size Encrypted and Reserved. These fields indicating partial encryption are specified by 1 bit to indicate which fields of the EHT NDPA frame are partially encrypted.

As shown in FIG. 40, in the partial encryption frame format of the ranging NDPA frame, the Partial Encryption Info field within the Encryption Information field includes the following fields: AID11 Encrypted, LTF Offset Encrypted, R2I N_STS Encrypted, R2I Rep Encrypted, I2R N_STS Encrypted, 12R Rep Encrypted and Reserved. These fields indicating partial encryption are specified by 1 bit to indicate which fields of the ranging NDPA frame are partially encrypted.

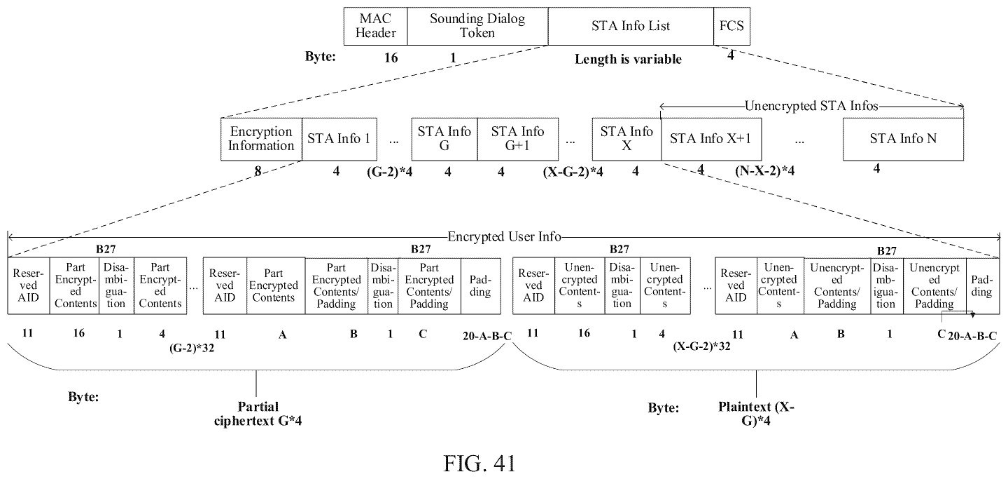

In HE/EHT/ranging NDPA frames, the Encrypted User Info field is configured to carry the partially encrypted ciphertext and the unencrypted plaintext of the STA Info. For example, a frame format of the HE/EHT/ranging NDPA frame is illustrated in FIG. 41.

The Encrypted User Info field consists of two parts, which are the partially encrypted ciphertext (referred to as partial ciphertext, for example, including G×4 bytes) and the unencrypted plaintext (for example, including (X−G)×4 bytes). In the case that encryption protection is needed, the AP performs unified encryption on the parts of the STA Info that need to be encrypted. The encrypted ciphertext is placed in the Partial Encrypted Contents and padded to an integer multiple of 4, and the unencrypted plaintext parts are placed in the Unencrypted Contents in the original STA Info order. The new version STA performs decryption after reception. Since it is known which parts are encrypted, the original STA Info can be reassembled in order upon decrypting the ciphertext field.

To ensure compatibility with Legacy-STAs, in HE/EHT/ranging NDPA frames, the two field parts of ciphertext and plaintext within the Encrypted User Info field need to be disambiguated every other 4 bytes using a reserved AID.

Additionally, the VHT NDPA frame involves a small number of fields that could potentially leak privacy, and details will not be elaborated here. For partial encryption, the design of HE/EHT/ranging NDPA can be referenced, and the Encrypted User Info field should be an integer multiple of 2 bytes. Compatibility considerations in units of two bytes can be implemented by Disambiguation and reserved AID. In the VHT NDPA frame, the two field parts of ciphertext and plaintext within the Encrypted User Info field need to be disambiguated every other 2 bytes using a reserved AID.

In the embodiments of the present disclosure, protection such as encryption and/or digest protection is applied to the trigger frame and/or the NDPA frame. The introduced protection mechanisms, including encryption and/or digest, serve to protect fields within the trigger frame and/or the NDPA frame that may reveal private information. Moreover, for the protection mechanisms targeting the trigger frame and/or the NDPA frame, the announcement of encryption capabilities of STAs and APs are completed by adding an Encryption Capability Information Element to at least one of the association request frame, the association response frame and the authentication frame.

For the protection mechanism targeting the trigger frame, STAs are assisted in decryption by adding an Encryption Information field to the User Info List. For the protection mechanism targeting the NDPA frame, STAs are assisted in decryption by adding an Encryption Information field to the STA Info List. For the protection mechanisms targeting the trigger frame and/or the NDPA frame, compatibility with Legacy-STAs is ensured by using the reserved AID value and/or the setting of Disambiguation bit within the trigger frame, and compatibility with Legacy-STAs is ensured by using the reserved AID value and/or the setting of Disambiguation bit within NDPA frame. For the protection mechanisms targeting the trigger frame and/or the NDPA frame, the partial encryption and/or partial digestion methods are utilized for fields at risk of information leakage, improving the flexibility of encryption and/or digestion and reducing overhead. For the protection mechanisms targeting the trigger frame and/or the NDPA frame, different protection methods, such as the requirements for plaintext length by encryption methods, are considered. A unified encryption method for the User Info/STA Info of a plurality of users is provided to reduce overhead.

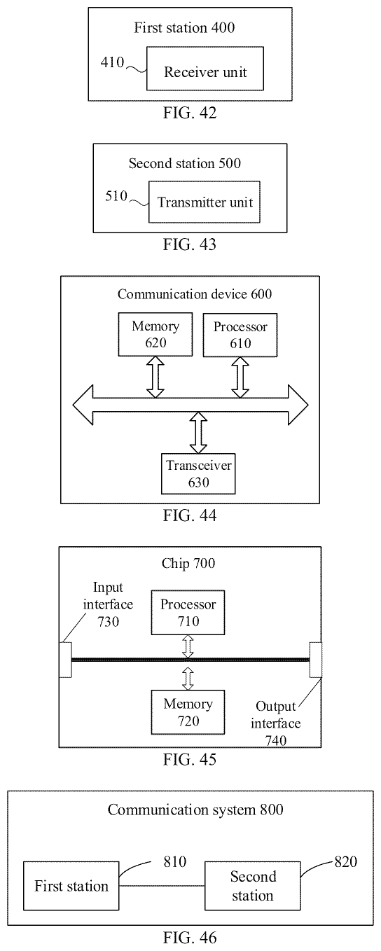

FIG. 42 is a schematic block diagram of a first station 400 according to some embodiments of the present disclosure.

The first station 400 includes: a receiver unit 410, configured to receive a control frame. The control frame carries first information and/or second information, wherein the first information is configured to identify the second information, and the second information includes protected information.

In some embodiments, the first station 400 further includes: a transmitter unit, configured to transmit the protection capability information of a first STA for the control frame.

In some embodiments, the protection capability information of the first STA for the control frame is contained in an association request frame and/or a first authentication frame transmitted the first STA.

In some embodiments, the association request frame and/or the first authentication frame include a first protection capability information field. The first protection capability information field carries the protection capability information of the first STA for the control frame.

In some embodiments, the first protection capability information field includes at least one of: a first field indicating trigger frame protection capability, a first field indicating NDPA frame protection capability, a first field indicating multi-STA BA frame protection capability, a first field indicating BA frame protection capability, and a reserved field.

In some embodiments, the first protection capability information field further includes a first element identifier field.

In some embodiments, the first element identifier field carries a specified element identifier.

In some embodiments, the first protection capability information field further includes a second element identifier field and/or a first element identifier extension field.

In some embodiments, a value of the second element identifier field is 255; and the first element identifier extension field carries a specified element extension identifier.

In some embodiments, the association request frame and/or the first authentication frame include a first extended capability field. The first extended capability field carries the protection capability information of the first STA for the control frame.

In some embodiments, the first extended capability field includes at least one of: a second field indicating trigger frame protection capability, a second field indicating NDPA frame protection capability, a second field indicating multi-STA BA frame protection capability, a second field indicating BA frame protection capability, and a reserved field.

In some embodiments, the first extended capability field further includes a third element identifier field.

In some embodiments, the receiver unit is further configured to receive protection capability information of a second STA for the control frame.

In some embodiments, the protection capability information of the second STA for the control frame is contained in an association response frame and/or a second authentication frame received by the first STA.

In some embodiments, the association response frame and/or the second authentication frame include a second protection capability information field. The second protection capability information field carries the protection capability information of the second STA for the control frame.

In some embodiments, the second protection capability information field includes at least one of: a third field indicating trigger frame protection capability, a third field indicating NDPA frame protection capability, a third field indicating multi-STA BA frame protection capability, a third field indicating BA frame protection capability, and a reserved field.

In some embodiments, the second protection capability information field further includes a fourth element identifier field.

In some embodiments, the fourth element identifier field carries a specified element identifier.

In some embodiments, the second protection capability information field further includes a fifth element identifier field and/or a second element identifier extension field.

In some embodiments, a value of the fifth element identifier field is 255; and the second element identifier extension field carries a specified element extension identifier.

In some embodiments, the association response frame and/or the second authentication frame include a second extended capability field. The second extended capability field carries the protection capability information of the second STA for the control frame.

In some embodiments, the second extended capability field further includes at least one of: a fourth field indicating trigger frame protection capability, a fourth field indicating NDPA frame protection capability, a fourth field indicating multi-STA BA frame protection capability, a fourth field indicating BA frame protection capability, and a reserved field.

In some embodiments, the second extended capability field includes a sixth element identifier field.

In some embodiments, the first station further includes a processing unit, wherein the processing unit is configured to identify the second information based on the first information.

In some embodiments, the processing unit identifying the second information based on the first information includes: acquiring a first verification information by decrypting, based on the first information, the second information.

In some embodiments, the processing unit decrypting the second information based on the first information includes: extracting the second information based on the number of an original information and/or a length corresponding to each piece of information; and extracting a valid ciphertext from the second information based on an encryption algorithm and decrypting the valid ciphertext.

In some embodiments, the processing unit decrypting the valid ciphertext further includes: continuing to decrypt a protected content within the valid ciphertext in the case that the AID read from the valid ciphertext is a specified AID. The specified AID belongs to a reserved AID value.

In some embodiments, the processing unit decrypting the valid ciphertext further includes: stopping the decryption in the case that an AID read from the valid ciphertext is a specified AID. For example, in the case that the AID read from the valid ciphertext is the reserved AID value, the protected content within the valid ciphertext is skipped, and the decryption is stopped.

In some embodiments, the number of the original information, the length corresponding to each piece of information, and the encryption algorithm are acquired from the first information.

In some embodiments, the encryption algorithm and the length corresponding to each piece of information are known, and the number of the original information is acquired from the first information.

In some embodiments, the processing unit decrypting the second information based on the first information further includes: extracting a valid plaintext from a decrypted plaintext.

In some embodiments, the valid plaintext is part of the fields of the original information. The processing unit decrypting the second information based on the first information further includes: restoring and acquiring the original information by inserting the valid plaintext into the unencrypted plaintext of the original information in the order corresponding to the respective fields in the frame format and/or the encryption order of the original information.

In some embodiments, the processing unit identifying the second information based on the first information includes: acquiring a second verification information by digesting, based on a digest algorithm, all or part of the fields of the original information; and the first STA, in the case that the second verification information is consistent with the second information, confirming the identification as successful.

In some embodiments, the processing unit identifying the second information based on the first information includes: acquiring a third verification information by digesting, based on a digest algorithm, all or part of the fields of the original information; acquiring a fourth verification information by encrypting, based on an encryption algorithm, the third verification information; and confirming the identification as successful in the case that the fourth verification information is consistent with the second information.

In some embodiments, the second information includes the encrypted information and the digested information. The processing unit identifying the second information based on the first information includes: acquiring a fifth verification information by decrypting, based on an encryption algorithm, the encrypted information; acquiring a sixth verification information by digesting, based on a digest algorithm, the fifth verification information; and confirming the identification as successful in the case that the sixth verification information is consistent with the digested information.

In some embodiments, the first information includes at least one of the following fields: a specified AID, a protection method, a length of the processed result corresponding to each piece of original information and the number of the original information. The specified AID in the first information belongs to the reserved AID value.

In some embodiments, the protection method includes an encryption algorithm and/or a digest algorithm.

In some embodiments, the second information includes a specified AID and/or a disambiguation bit, wherein the specified AID in the second information is different from the specified AID in the first information. The specified AID in the second information belongs to the reserved AID value.

In some embodiments, the second information further includes a protected content field.

In some embodiments, the protected content field further includes an encrypted content field and/or a digested content field.

In some embodiments, the second information further includes a padding field and/or a scrambling field.

In some embodiments, the second information is acquired by uniformly processing M pieces of original information, wherein M is a positive integer.

In some embodiments, the second information is acquired by individually processing M pieces of original information, wherein M is a positive integer.

In some embodiments, the second information is acquired by processing part of the fields of M pieces of original information, wherein M is a positive integer.

In some embodiments, the first information further includes a partial protection information field. The partial protection information field is configured to indicate part of the fields in the original information that need to be protected.

In some embodiments, the control frame is a trigger frame. The second information in the trigger frame includes the protected user information User Info.

In some embodiments, the protected User Info in the trigger frame includes one protected User Info field. The protected User Info field is acquired by processing M original User Info fields, wherein M is a positive integer.

In some embodiments, the protected User Info in the trigger frame includes a plurality of protected User Info fields. Each of the protected User Info fields is acquired by processing one original User Info field.

In some embodiments, the protected User Info in the trigger frame includes a partially protected User Info field and an unprotected User Info field. The partially protected User Info field is acquired by processing part of the fields in M original User Info fields.

In some embodiments, a reserved AID value is included in the partially protected User Info field and the unprotected User Info field every other 5 bytes.

In some embodiments, a total length of a protected part in the trigger frame is ┌M1×k1÷5┐×5 bytes, wherein k1 represents a length of a processed result corresponding to the original User Info field, M1 represents the number of the original User Info fields, and both k1 and M1 are positive integers.

In some embodiments, a total length of the protected part in the trigger frame is ┌M1×k1÷5┐×5 bytes, wherein k1 represents a length of a processed result corresponding to part of the fields in the original User Info field, M1 represents the number of the original User Info fields, and both k1 and M1 are positive integers.

In some embodiments, in the case of individual encryption, the total length of the protected part in the trigger frame is also M1×(┌k1÷5┐×5) bytes.

In some embodiments, first 12 bits of the protected User Info in the trigger frame include at least two disambiguation bits.

In some embodiments, the disambiguation bits in the first 12 bits of the protected User Info in the trigger frame include an 11^{th} bit B10 and a 12^{th} bit B11, wherein a numerical value composed of B10 and B11 along with previous 10 bits of protected content is a reserved AID value.

In some embodiments, B10=0 and B11=1.

In some embodiments, the disambiguation bits in the first 12 bits of the protected User Info in the trigger frame include a 10^{th} bit B9, an 11^{th} bit B10, and a 12^{th} bit B11, wherein a numerical value composed of B9, B10 and B11 along with previous 9 bits of protected content is a reserved AID value.

In some embodiments, B9=0, B10=1, and B11=1.

In some embodiments, the control frame is an NDPA frame. The second information in the NDPA frame includes protected station information (STA Info).

In some embodiments, the first information of the NDPA frame further includes a disambiguation bit.

In some embodiments, the protected STA Info in the NDPA frame includes one protected STA Info field. The protected STA Info field is acquired by processing M original STA Info fields, wherein M is a positive integer.

In some embodiments, the protected STA Info in the NDPA frame includes a plurality of protected STA Info fields. Each of the protected STA Info fields is acquired by processing one original STA Info field.

In some embodiments, the protected STA Info in the NDPA frame includes a partially protected STA Info field and an unprotected STA Info field. The partially protected STA Info field is acquired by processing part of the fields in M original STA Info fields.

In some embodiments, the NDPA frame is a VHT NDPA frame.

In some embodiments, in the VHT NDPA frame, a reserved AID value is included in the partially protected STA Info field and the unprotected STA Info field every other 2 bytes.

In some embodiments, a total length of a protected part in the VHT NDPA frame is ┌M2×k2÷2┐×2 bytes, wherein k2 represents a length of a processed result corresponding to the original STA Info field, M2 represents the number of the original STA Info fields, and both k2 and M2 are positive integers.

In some embodiments, a total length of a protected part in the VHT NDPA frame is ┌M2×k2÷2┐×2 bytes, wherein k2 represents a length of a processed result corresponding to part of the fields in the original STA Info field, M2 represents the number of the original STA Info fields, and both k2 and M2 are positive integers.

In some embodiments, in the case of individual encryption, a total length of the protected part in the VHT NDPA frame is also M2×(┌k2÷2┐×2) bytes.

In some embodiments, in the VHT NDPA frame, the disambiguation bit in the first 12 bits of the protected STA Info is a 12^{th} bit B11.

In some embodiments, the NDPA frame is an HE NDPA frame, an EHT NDPA frame or a ranging NDPA frame.

In some embodiments, in the HE NDPA frame, the EHT NDPA frame or the Ranging NDPA frame, a reserved AID is included in the partially protected STA Info field and the unprotected STA Info field every other 4 bytes. The specified AID belongs to a reserved AID value.

In some embodiments, a total length of a protected part in the HE NDPA frame, the EHT NDPA frame or the ranging NDPA frame is ┌M3×k3÷4┐×4 bytes, wherein k3 represents a length of the processed result corresponding to the original STA Info field, M3 represents the number of the original STA Info fields, and both k3 and M3 are positive integers.

In some embodiments, a total length of a protected part in the HE NDPA frame, the EHT NDPA frame or the ranging NDPA frame is ┌M3×k3÷4┐×4 bytes, wherein k3 represents a length of a processed result corresponding to part of the fields in the original STA Info field, M3 represents the number of the original STA Info fields, and both k3 and M3 are positive integers.

In some embodiments, in the case of individual encryption, the total length of the protected part in the HE NDPA frame, the EHT NDPA frame or the ranging NDPA frame is also M3×(┌k3÷4┐×4) bytes.

In the embodiments of the present disclosure, ┌ ┐ denotes rounding up to the nearest integer.

In some embodiments, in the HE NDPA frame, the EHT NDPA frame or the ranging NDPA frame, the disambiguation bit in first 28 bits of the protected STA Info is a 28^{th} bit B27.

The first station 400 according to the embodiments of the present disclosure can implement the corresponding functions of the first station in the aforementioned method embodiments. The processes, functions, implementation methods and beneficial effects corresponding to various modules (submodules, units, or components, or the like) within the first station 400 can be referred to the corresponding descriptions in the aforementioned method embodiments 1000, which are not reiterated here. It should be noted that the functions described for various modules (submodules, units, or components, or the like) within the first station 400 according to the embodiments of the present disclosure can be implemented by different modules (submodules, units, or components, or the like), or by the same module (submodule, unit, or component, or the like).

FIG. 43 is a schematic block diagram of the second station 500 according to some embodiments of the present disclosure.

The second station 500 includes: a transmitter unit 510, configured to transmit a control frame. The control frame carries first information and/or second information, wherein the first information is configured to identify the second information, and the second information includes protected information.

In some embodiments, the second station 500 further includes a receiver unit, configured to receive the protection capability information of a first STA for the control frame.

In some embodiments, the protection capability information of the first STA for the control frame is contained in an association request frame and/or a first authentication frame transmitted by the first STA.

In some embodiments, the association request frame and/or the first authentication frame include a first protection capability information field. The first protection capability information field carries the protection capability information of the first STA for the control frame.

In some embodiments, the first protection capability information field includes at least one of: a first field indicating trigger frame protection capability, a first field indicating null data PPDU announcement (NDPA) frame protection capability, a first field indicating multi-STA BA frame protection capability, a first field indicating BA frame protection capability, and a reserved field.

In some embodiments, the first protection capability information field further includes a first element identifier field.

In some embodiments, the first element identifier field carries a specified element identifier.

In some embodiments, the first protection capability information field further includes a second element identifier field and/or a first element identifier extension field.

In some embodiments, a value of the second element identifier field is 255; and the first element identifier extension field carries a specified element extension identifier.

In some embodiments, the association request frame and/or the first authentication frame include a first extended capability field. The first extended capability field carries the protection capability information of the first STA for the control frame.

In some embodiments, the first extended capability field includes at least one: a second field indicating trigger frame protection capability, a second field indicating NDPA frame protection capability, a second field indicating multi-STA BA frame protection capability, a second field indicating BA frame protection capability, and a reserved field.

In some embodiments, the first extended capability field further includes a third element identifier field.

In some embodiments, the transmitter unit is further configured to transmit the protection capability information of the second STA for the control frame.

In some embodiments, the protection capability information of the second STA for the control frame is contained in an association response frame and/or a second authentication frame received by the first STA.

In some embodiments, the association response frame and/or the second authentication frame include a second protection capability information field. The second protection capability information field carries the protection capability information of the second STA for the control frame.

In some embodiments, the second protection capability information field includes at least one of: a third field indicating trigger frame protection capability, a third field indicating NDPA frame protection capability, a third field indicating multi-STA BA frame protection capability, a third field indicating BA frame protection capability, and a reserved field.

In some embodiments, the second protection capability information field further includes a fourth element identifier field.

In some embodiments, the fourth element identifier field carries a specified element identifier.

In some embodiments, the second protection capability information field further includes a fifth element identifier field and/or a second element identifier extension field.

In some embodiments, a value of the fifth element identifier field is 255; and the second element identifier extension field carries a specified element extension identifier.

In some embodiments, the association response frame and/or the second authentication frame include a second extended capability field. The second extended capability field carries the protection capability information of the second STA for the control frame.

In some embodiments, the second extended capability field further includes at least one of: a fourth field indicating trigger frame protection capability, a fourth field indicating NDPA frame protection capability, a fourth field indicating multi-STA BA frame protection capability, a fourth field indicating BA frame protection capability, and a reserved field.

In some embodiments, the second extended capability field includes a sixth element identifier field.

In some embodiments, the second station further includes a processing unit, wherein the processing unit is configured to acquire the second information by processing, based on the first information, the original information.

In some embodiments, the processing unit acquiring the second information by processing, based on the first information, the original information includes: acquiring the second information by encrypting, based on the first information, the original information.

In some embodiments, the processing unit acquiring the second information by encrypting, based on the first information, the original information includes: acquiring a valid ciphertext by padding and encrypting, based on an encryption algorithm, the original information; and acquiring the second information by padding the valid ciphertext.

In some embodiments, the processing unit acquiring the second information by processing, based on the first information, the original information includes: acquiring the second information by digesting, based on the first information, all or part of the fields of the original information.

In some embodiments, the processing unit acquiring the second information by processing, based on the first information, the original information further includes: acquiring the second information by digesting, based on the first information, all or part of the fields of the original information and encrypting digested information.

In some embodiments, the processing unit acquiring the second information by processing, based on the first information, the original information includes: acquiring encrypted information by encrypting, based on the first information, the original information; acquiring digested information by digesting, based on the first information, the original information; and acquiring the second information based on the encrypted information and the digested information.

In some embodiments, the first information includes at least one of the following fields: the specified AID, the protection method, the length of the processed result corresponding to each piece of original information, and the number of the original information. The specified AID in the first information belongs to the reserved AID value.

In some embodiments, the protection method includes an encryption algorithm and/or a digest algorithm.

In some embodiments, the second information includes a specified AID and/or a disambiguation bit, wherein the specified AID in the second information is different from the specified AID in the first information. The specified AID in the second information belongs to the reserved AID value.

In some embodiments, the second information further includes a protected content field.

In some embodiments, the protected content field further includes an encrypted content field and/or a digested content field.

In some embodiments, the second information further includes a padding field and/or a scrambling field.

In some embodiments, the second information is acquired by uniformly processing M pieces of original information, wherein M is a positive integer.

In some embodiments, the second information is acquired by individually processing M pieces of original information, wherein M is a positive integer.

In some embodiments, the second information is acquired by processing part of the fields of M pieces of original information, wherein M is a positive integer.

In some embodiments, the first information further includes a partial protection information field. The partial protection information field is configured to indicate part of the fields in the original information that need to be protected.

In some embodiments, the control frame is a trigger frame. The second information in the trigger frame includes the protected user information User Info.

In some embodiments, the protected User Info in the trigger frame includes one protected User Info field. The protected User Info field is acquired by processing M original User Info fields, wherein M is a positive integer.

In some embodiments, the protected User Info in the trigger frame includes a plurality of protected User Info fields. Each of the protected User Info fields is acquired by processing one original User Info field.

In some embodiments, the protected User Info in the trigger frame includes a partially protected User Info field and an unprotected User Info field. The partially protected User Info field is acquired by processing part of the fields in M original User Info fields.

In some embodiments, a reserved AID value is included in the partially protected User Info field and the unprotected User Info field every other 5 bytes.

In some embodiments, a total length of a protected part in the trigger frame is ┌M1×k1÷5┐×5 bytes, wherein k1 represents length of a processed result corresponding to the original User Info field, M1 represents the number of the original User Info fields, and both k1 and M1 are positive integers.

In some embodiments, a total length of a protected part in the trigger frame is ┌M1×k1÷5┐×5 bytes, wherein k1 represents a length of a processed result corresponding to part of the fields in the original User Info field, M1 represents the number of the original User Info fields, and both k1 and M1 are positive integers.

In some embodiments, in the case of individual encryption, the total length of the protected part in the trigger frame is also M1×(┌k1÷5┐×5) bytes.

In some embodiments, first 12 bits of the protected User Info in the trigger frame include at least two disambiguation bits.

In some embodiments, the disambiguation bits in the first 12 bits of the protected User Info in the trigger frame include an 11^{th} bit B10 and a 12^{th} bit B11, wherein a numerical value composed of B10 and B11 along with previous 10 bits of protected content is a reserved AID value. In some embodiments, B10=0 and B11=1.

In some embodiments, the disambiguation bits in the first 12 bits of the protected User Info in the trigger frame include a 10^{th} bit B9, an 11^{th} bit B10, and a 12^{th} bit B11, wherein a numerical value composed of B9, B10, and B11 along with previous 9 bits of protected content is a reserved AID value.

In some embodiments, B9=0, B10=1, and B11=1.

In some embodiments, the control frame is an NDPA frame. The second information in the NDPA frame includes the protected station information (STA Info).

In some embodiments, the first information of the NDPA frame further includes a disambiguation bit.

In some embodiments, the protected STA Info in the NDPA frame includes one protected STA Info field. The protected STA Info field is acquired by processing M original STA Info fields, wherein M is a positive integer.

In some embodiments, the protected STA Info in the NDPA frame includes a plurality of protected STA Info fields. Each of the protected STA Info fields is acquired by processing one original STA Info field.

In some embodiments, the protected STA Info in the NDPA frame includes a partially protected STA Info field and an unprotected STA Info field. The partially protected STA Info field is acquired by processing part of the fields in M original STA Info fields.

In some embodiments, the NDPA frame is a VHT NDPA frame.

In some embodiments, in the VHT NDPA frame, a reserved AID value is included in the partially protected STA Info field and the unprotected STA Info field every other 2 bytes.

In some embodiments, a total length of a protected part in the VHT NDPA frame is ┌M2×k2÷2┐×2 bytes, wherein k2 represents a length of a processed result corresponding to the original STA Info field, M2 represents the number of the original STA Info fields, and both k2 and M2 are positive integers.

In some embodiments, a total length of a protected part in the VHT NDPA frame is ┌M2×k2÷2┐×2 bytes, wherein k2 represents a length of a processed result corresponding to part of the fields in the original STA Info field, M2 represents the number of the original STA Info fields, and both k2 and M2 are positive integers.

In some embodiments, in the case of individual encryption, the total length of the protected part in the VHT NDPA frame is also M2×(┌k2÷2┐×2) bytes.

In some embodiments, in the VHT NDPA frame, the disambiguation bit in the first 12 bits of the protected STA Info is a 12^{th} bit B11.

In some embodiments, the NDPA frame is an HE NDPA frame, an EHT NDPA frame, or a ranging NDPA frame.

In some embodiments, in the HE NDPA frame, the EHT NDPA frame or the Ranging NDPA frame, a reserved AID is included in the partially protected STA Info field and the unprotected STA Info field every other 4 bytes.

In some embodiments, a total length of a protected part in the HE NDPA frame, the EHT NDPA frame or the ranging NDPA frame is ┌M3×k3÷4┐×4 bytes, wherein k3 represents a length of a processed result corresponding to the original STA Info field, M3 represents the number of the original STA Info fields, and both k3 and M3 are positive integers.

In some embodiments, a total length of the protected part in the HE NDPA frame, the EHT NDPA frame or the ranging NDPA frame is ┌M3×k3÷4┐×4 bytes, wherein k3 represents a length of a processed result corresponding to part of the fields in the original STA Info field, M3 represents the number of the original STA Info fields, and both k3 and M3 are positive integers.

In some embodiments, in the case of individual encryption, the total length of the protected part in the HE NDPA frame, the EHT NDPA frame or the ranging NDPA frame is also M3×(┌k3÷4┐×4) bytes.

In the embodiments of the present disclosure, ┌ ┐ denotes rounding up to the nearest integer.

In some embodiments, in the HE NDPA frame, the EHT NDPA frame or the ranging NDPA frame, the disambiguation bit in first 28 bits of the protected STA Info is a 28^{th} bit B27.

The second station 500 according to the embodiments of the present disclosure can implement the corresponding functions of the second station in the aforementioned method embodiments. The processes, functions, implementation methods, and beneficial effects corresponding to various modules (submodules, units, or components, or the like) within the second station 500 can be referred to the corresponding descriptions in the aforementioned method embodiments 1100, which are not repeated herein. It should be noted that the functions described for various modules (submodules, units, or components, or the like) within the second station 500 according to the embodiments of the present disclosure can be implemented by different modules (submodules, units, or components, or the like), or by the same module (submodule, unit, or component, or the like).

FIG. 44 is a schematic diagram of a structure of a communication device 600 according to some embodiments of the present disclosure. The communication device 600 includes a processor 610. The processor 610, when loading and running a computer program stored in a memory, causes the communication device 600 to perform the methods in the embodiments of the present disclosure.

In some embodiments, the communication device 600 further includes a memory 620. The processor 610, when loading and running a computer program from the memory 620, causes the communication device 600 to perform the methods in the embodiments of the present disclosure. The memory 620 may be a separate device independent from the processor 610 or can be integrated within the processor 610.

In some embodiments, the communication device 600 further includes a transceiver 630. The processor 610 controls the transceiver 630 to communicate with other devices. For example, the processor 610 controls the transceiver 630 to transmit information or data to other devices, or to receive information or data transmitted by other devices. The transceiver 630 includes a transmitter and a receiver. The transceiver 630 further includes one or more antennas.

In some embodiments, the communication device 600 serves as the second station in the embodiments of the present disclosure. Additionally, the communication device 600 performs the corresponding processes performed by the second station in various methods of the embodiments of the present disclosure. For brevity, details are not repeated herein.

In some embodiments, the communication device 600 serves as the first station in the embodiments of the present disclosure. Additionally, the communication device 600 performs the corresponding processes performed by the first station in various methods of the embodiments of the present disclosure. For brevity, details are not repeated herein.

FIG. 45 is a schematic diagram of a structure of a chip 700 according to some embodiments of the present disclosure. The chip 700 includes a processor 710. The processor 710, when loading and running a computer program stored in a memory, is caused to perform the methods in the embodiments of the present disclosure.

In some embodiments, the chip 700 further includes a memory 720. The processor 710, when loading and running a computer programs stored in the memory 720, is caused to perform the methods performed by the first station or the second station in the embodiments of the present disclosure. The memory 720 can be a separate device independent from the processor 710 or can be integrated within the processor 710.

In some embodiments, the chip 700 further includes an input interface 730. The processor 710 controls the input interface 730 to communicate with other devices or chips. For example, the processor 710 controls the input interface 730 to acquire information or data from other devices or chips.

In some embodiments, the chip 700 further includes an output interface 740. The processor 710 controls the output interface 740 to communicate with other devices or chips. For example, the processor 710 controls the output interface 740 to output information or data to other devices or chips.

In some embodiments, the chip is applied to the second station in the embodiments of the present disclosure. Additionally, the chip performs the corresponding processes performed by the second station in various methods of the embodiments of the present disclosure. For brevity, details are not repeated herein.

In some embodiments, the chip is applied to the first station in the embodiments of the present disclosure. Additionally, the chip performs the corresponding processes performed by the first station in various methods of the embodiments of the present disclosure. For brevity, details are not repeated herein.

The chips applied to the second station and the first station can be the same or different.

It is understandable that the chip mentioned in the embodiments of the present disclosure can also be referred to as a system-on-chip, a system chip, a chip system or an on-chip system.

The aforementioned processor can be a general-purpose processor, a digital signal processor (DSP), a field-programmable gate array (FPGA), an application-specific integrated circuit (ASIC), or other programmable logic devices, transistor logic devices, discrete hardware components, or the like. The aforementioned general-purpose processor can be a microprocessor or any conventional processor, or the like.

The memory may be a volatile memory or a non-volatile memory, or may include both a volatile memory and a non-volatile memory. The non-volatile memory can be a read-only memory (ROM), a programmable ROM (PROM), an erasable PROM (EPROM), an electrically EPROM (EEPROM) or flash memory. The volatile memory can be a random-access memory (RAM).

It is understandable that the memories are exemplary but not limiting. For example, the memory in the embodiments of the present disclosure can also be a static RAM (SRAM), a dynamic RAM (DRAM), a synchronous DRAM (SDRAM), a double data rate SDRAM (DDR SDRAM), an enhanced SDRAM (ESDRAM), a synchronous link DRAM (SLDRAM), a direct rambus RAM (DR RAM), or the like. In other words, the memory in the embodiments of the present disclosure is intended to include, but is not limited to, these and any other suitable types of memory.

FIG. 46 is a schematic block diagram of a communication system 800 according to some embodiments of the present disclosure. The communication system 800 includes a first station 810 and a second station 820. The first STA810 is configured to receive a control frame carrying the first information and/or the second information. The first information is configured to identify the second information, and the second information includes protected information. The second STA820 is configured to transmit a control frame carrying the first information and/or the second information. The first information is configured to identify the second information, and the second information includes protected information. The first station 810 is configured to implement the corresponding functions implemented by the first station in the aforementioned methods, and the second station 820 is configured to implement the corresponding functions implemented by the second station in the aforementioned methods. For brevity, details are not repeated herein.

The above embodiments can be fully or partially practiced by software, hardware, firmware or any combination thereof. In the case of practice with software, the embodiments may be fully or partially practiced in the form of a computer program product. The computer program product includes one or more computer instructions. In the case that the computer program instructions are loaded and run on a computer, the computer program instructions generate, fully or partially, the processes or functions based on the embodiments of the present disclosure. The computer can be a general-purpose computer, a specialized computer, a computer network or any other programmable apparatus. The computer instructions are stored in a computer readable storage medium or transmitted from one computer-readable storage medium to another computer readable storage medium. For example, the computer instructions are transmitted from one website, computer, server, or data center to another website, computer, server, or data center via wired, such as coaxial cable, fiber optic, digital subscriber line (DSL) or wireless, such as infrared, wireless, microwave, and the like means. The computer readable storage medium can be any available medium accessible by a computer or can be a data storage device such as a server, a data center, and the like, that includes one or more integrated available media. The available medium can be a magnetic medium, such as a floppy disk, hard disk, magnetic tape, an optical medium, such as a DVD, or a semiconductor medium, such as a solid state disk (SSD), or the like.

It is understandable that in the various embodiments of the present disclosure, the numerical order of the above-mentioned processes does not imply a sequence of execution. The execution order of these processes should be determined by their functions and internal logic, and should not impose any limitation on the implementation of the embodiments of the present disclosure.

Those skilled in the art can clearly understand that, for convenience and brevity in description, specific working processes of the systems, apparatuses and units described above can refer to the corresponding processes in the aforementioned method embodiments, which are not reiterated here.

The above descriptions are only specific embodiments of the present disclosure, but the protection scope of the present disclosure is not limited to these. Any technical personnel skilled in the art can easily think of a change or a substitution within the technical scope of the present disclosure, and the change or the substitution should be covered within the protection scope of the present disclosure. Therefore, the protection scope of the present disclosure shall be subject to the protection scope of the claims.

1. A communication method, comprising:
receiving, by a first station (STA), a control frame carrying first information and/or second information, wherein the first information is configured to identify the second information, and the second information comprises protected information.

2. The method according to claim 1, further comprising:
transmitting, by the first STA, protection capability information of the first STA for the control frame.

3. The method according to claim 1, further comprising:
acquiring a second verification information by digesting, by the first STA and based on a digest algorithm, all or part of fields of original information, wherein the digest algorithm comprises at least one of hash-based message authentication code, cipher block chaining MAC (CBC-MAC), Galois message authentication code (GMAC), counter with CBC-MAC (CCM), Galois/counter mode (GCM); and
confirming, by the first STA, the identification as successful, in a case that the second verification information is consistent with the second information.

4. The method according to claim 1, wherein the first information comprises at least one of the following fields:
a specified AID;
a protection method;
a length of a processed result corresponding to each piece of original information; and
a number of the original information.

5. The method according to claim 1, wherein the second information comprises a protected content field and at least one of a specified AID or a disambiguation bit, and the specified AID in the second information is different from the specified AID in the first information.

6. The method according to claim 1, wherein the control frame is a trigger frame, and the second information in the trigger frame comprises protected user information (User Info); or
wherein the control frame is an NDPA frame, and the second information in the NDPA frame comprises protected station information (STA Info).

7. The method according to claim 6, wherein in the case that the control frame is the trigger frame and the second information in the trigger frame comprises protected User Info:
the protected User Info in the trigger frame comprises one protected User Info field, and the protected User Info field is acquired by processing M original User Info fields, M being a positive integer; or
the protected User Info in the trigger frame comprises a plurality of protected User Info fields, and each of the protected User Info fields is acquired by processing one original User Info field; or
the protected User Info in the trigger frame comprises a partially protected User Info field and an unprotected User Info field, wherein the partially protected User Info field is acquired by processing part of fields in M original User Info fields; and
wherein in the case that the control frame is the NDPA frame and the second information in the NPDA frame comprises protected STA Info:
the protected STA Info in the NDPA frame comprises one protected STA Info field, wherein the protected STA Info field is acquired by processing M original STA Info fields, M being a positive integer; or
the protected STA Info in the NDPA frame comprises a plurality of protected STA Info fields, and each of the protected STA Info fields is acquired by processing one original STA Info field; or
the protected STA Info in the NDPA frame comprises a partially protected STA Info field and an unprotected STA Info field, wherein the partially protected STA Info field is acquired by processing part of fields in M original STA Info fields.

8. A first station (STA), comprising:
a processor and a memory, wherein the memory is configured to store a computer program, which when executed by the processor, causes the first STA to:
receive a control frame carrying first information and/or second information, wherein the first information is configured to identify the second information, and the second information comprises protected information.

9. The first STA according to claim 8, wherein the computer program, which when executed by the processor, further causes the first STA to:
transmit protection capability information of the first STA for the control frame.

10. The first STA according to claim 8, wherein the computer program, which when executed by the processor, further causes the first STA to:
acquire a second verification information by digesting and based on a digest algorithm, all or part of fields of original information, wherein the digest algorithm comprises at least one of hash-based message authentication code, cipher block chaining MAC (CBC-MAC), Galois message authentication code (GMAC), counter with CBC-MAC (CCM), Galois/counter mode (GCM); and
confirm the identification as successful, in a case that the second verification information is consistent with the second information.

11. The first STA according to claim 8, wherein the first information comprises at least one of the following fields:
a specified AID;
a protection method;
a length of a processed result corresponding to each piece of original information; and
a number of the original information.

12. The first STA according to claim 8, wherein the second information comprises a protected content field and at least one of a specified AID or a disambiguation bit, and the specified AID in the second information is different from a specified AID in the first information.

13. The first STA according to claim 8, wherein the control frame is a trigger frame, and the second information in the trigger frame comprises protected user information (User Info); or
wherein the control frame is an NDPA frame, wherein the second information in the NDPA frame comprises protected station information (STA Info).

14. The first STA according to claim 13, wherein in the case that the control frame is the trigger frame and the second information in the trigger frame comprises protected User Info:
the protected User Info in the trigger frame comprises one protected User Info field, and the protected User Info field is acquired by processing M original User Info fields, M being a positive integer; or
the protected User Info in the trigger frame comprises a plurality of protected User Info fields, and each of the protected User Info fields is acquired by processing one original User Info field; or
the protected User Info in the trigger frame comprises a partially protected User Info field and an unprotected User Info field, wherein the partially protected User Info field is acquired by processing part of fields in M original User Info fields; and
wherein in the case that the control frame is the NDPA frame and the second information in the NPDA frame comprises protected STA Info:
the protected STA Info in the NDPA frame comprises one protected STA Info field, wherein the protected STA Info field is acquired by processing M original STA Info fields, M being a positive integer; or
the protected STA Info in the NDPA frame comprises a plurality of protected STA Info fields, and each of the protected STA Info fields is acquired by processing one original STA Info field; or
the protected STA Info in the NDPA frame comprises a partially protected STA Info field and an unprotected STA Info field, wherein the partially protected STA Info field is acquired by processing part of fields in M original STA Info fields.

15. A second station (STA), comprising:
a processor and a memory, wherein the memory is configured to store a computer program, which when executed by the processor, causes the second STA to:
transmit a control frame carrying first information and/or second information, wherein the first information is configured to identify the second information, and the second information comprises protected information.

16. The second STA according to claim 15, wherein the computer program, which when executed by the processor, further causes the second STA to:
receive protection capability information of a first STA for the control frame.

17. The second STA according to claim 15, wherein the computer program, which when executed by the processor, further causes the second STA to:
acquire the second information by digesting and based on the first information, all or part of fields of the original information.

18. The second STA according to claim 15, wherein the first information comprises at least one of the following fields:
a specified AID;
a protection method;
a length of a processed result corresponding to each piece of original information; and
a number of the original information.

19. The second STA according to claim 15, wherein the second information comprises a protected content field and at least one of a specified AID or a disambiguation bit, and the specified AID in the second information is different from a specified AID in the first information.

20. The second STA according to claim 15, wherein the control frame is a trigger frame, and the second information in the trigger frame comprises protected user information (User Info); or
wherein the control frame is an NDPA frame, wherein the second information in the NDPA frame comprises protected station information (STA Info).
